(19) United States
(12) Patent Application Publication
(10) Pub. No.: US 2010/0288754 A1
(43) Pub. Date: Nov. 18, 2010

(54) ELECTRIC POWER SUPPLY APPARATUS

(75) Inventor: Yasuhiko Ookuma, Fukuoka (JP)

Correspondence Address: RADER FISHMAN & GRAUER PLLC, LION BUILDING, 1233 20TH STREET N.W., SUITE 501, WASHINGTON, DC, 20036, US

(73) Assignee: Kyushu Electric Power CO., Inc., Fukuoka (JP)

(21) Appl. No.: 12/733,787

(22) PCT Filed: Sep. 21, 2007
(86) PCT No.: PCT/JP2007/068412

§ 371 Date: Jun. 21, 2010

(51) Int. Cl. H05B 6/04

(52) U.S. Cl. 219/660

(57) ABSTRACT

A feeder capable of feeding power to a load such as an electric appliance without remodeling an IH cooker already owned at home and usually used for cooking by heat, and just by putting on a plate of the IH cooker with its power ON without the need of an outlet. The feeder (100) includes a power generating coil (10) for interlinking an alternating magnetic field generated by the IH cooker (300) having a proper pan sensing function to generate an induction current and supply to the load, a blocking part (40) connected between the coil (10) and the load (200), a sensing part (50) for detecting a physical quantity generated by the coil (10), the blocking part (40) and/or the load (200) for converting it into a corresponding signal, and a control part (20) for controlling to shut the blocking part (40) based on the signal output from the sensing part (50). The power generating coil (10) and the load (200) are blocked by the blocking part (40), and power consumption on the load (200) is put out of a specified range set with the power consumption by a magnetic cooker mounted on the IH cooker (300) as reference, thereby causing the IH cooker (300) to determine that the magnetic cooker is not mounted to interrupt the generation of the alternating magnetic field from the IH cooker (300).

### TECHNICAL FIELD

The present invention relates to an electric power supply apparatus capable of supplying an electric power to a load such as a domestic electrified appliance, using an induction current based on a high frequency inducing magnetic field, which is a heating principle of a cooking heater (i.e., an induction heating cooking appliance which is referred to as an IH cooking appliance hereinafter) utilizing an induction heating method.

### BACKGROUND OF ART

Recently, IH cooking appliances are prevailing in ordinary homes as high-safety cooking appliances because of no utilization of flames, no cause of carbon monoxide poisoning and so forth, in comparison with gas cooking appliances.

In this kind of IH cooking appliance, a magnet force creation coil is placed under a top plate formed of an insulation material, and is energized by a high frequency current (on the order of kHz) to thereby create an alternating magnet field so that eddy currents are induced in a metal pan (for example a steel pan) put on the top plate, whereby the metal pan is heated by Joule heat generated due to an electric resistance of the metal of the pan. In short, the IH cooking appliance is entirely to utilize the fact that the metal pan per se is heated by the induced eddy currents.

On the other hand, entirely-electrified houses are prevailing in ordinary homes, and, while lift styles are changing, a change of consciousness of home cooking is remarkable. Further, with prevailing the IH cooking appliances, various kinds of cooking method have appeared. Especially, in a certain cooking method, a mixer or a food processor is used, and there is a cooking method in which a cooling process is carried out after a heating process. Thus, in a kitchen, various kinds of electrified appliance (electrified cooking appliance) are used, and thus there is an increasing demand for higher facilities of the cooking appliances including the IH cooking appliance.

Although, among the IH cooking appliances, there are a fixed type IH cooking appliance installed in a built-in kitchen, a table type IH cooking appliance and so forth, these IH cooking appliances are only used as a heating appliance. Namely, both a gas cooking appliance and an IH cooking appliance, which are generally prevailing at present as a cooking appliance, are only utilized for heating, and are unsuitable for a cooking method involving a cooling process. In a case where the cooling process is needed in the cooking method, it is necessary to utilize ices, low-temperature insulation materials and so forth, refrigerated in a refrigerator with a freezer, and thus troublesome preparation and clearance work are demanded.

As stated above, while the IH cooking appliances have prevailed in ordinary homes, they are limited to only utilization of a heating cooker, and thus a consumer who has already possessed a gas cooking appliance has a feeling of opposition to an exchange of such a gas cooking appliance for an IH cooking appliance. Although an IH cooking appliance features the superior safety, cleanliness and efficiency in comparison with a gas cooking appliance, in the present, IH cooking appliances are prevented from being popularized because they are relatively expensive products. Thus, a research for enhancing an additional value of an IH cooking appliance is being advanced.

For example, a conventional cordless appliance includes a magnetism creating section and a load section: the magnetism creating section has a top plate on which the load section is placed, a primary coil provided beneath the top plate to create a high frequency magnetic field, an inverter for driving the primary coil, a receiving means and a pan detection means for detecting whether or not a pan exists; and the aforesaid load section has a secondary coil magnetically coupled to the aforesaid primary coil, a sending means, and a load circuit supplied with an electric power from the secondary coil, wherein the aforesaid inverter feeds a high frequency current to the aforesaid primary coil when the aforesaid receiving means receives a given signal from the aforesaid sending means, and when it is detected by the pan detection means that a pan is put on the aforesaid top plate (for example, see: Patent Document 1).

Also, a conventional cordless power source apparatus includes: a primary coil unit having at least a primary electromagnetic induction coil on a power transmitting side, and an inverter circuit which energizes and excites the primary electromagnetic induction coil; and a coaster type adaptor having at least a secondary coil on a power receiving side, and an electrical outlet section, wherein the primary coil unit and the coaster type adaptor face each other such that a countertop of a built-in kitchen is intervened therebetween (for example, see: Patent Document 2).

Also, a conventional cooling apparatus uses an electronic heating/cooling element such as a Peltier element or the like to cool a subject to be cooled, and utilizes an electromagnetic induction heating apparatus as a power supply source thereof in a kitchen, a dinning or the like. The cooling apparatus includes a driven coil which is generates an induced electric power when it is put in a magnetic field of a high-frequency induction field generating coil, and an electronic cooling element which is operated by a direct current produced from a current generated by the driven coil, with the subject to be cooled being cooled by a heat absorbing part of the electronic cooling element (for example, see: Patent Document 3).
Patent Document 1: JP-H05-184471 A
Patent Document 2: JP-2006-102055 A
Patent Document 3: JP-2007-064557 A

### DISCLOSURE OF THE INVENTION

### Problems to be Resolved by the Invention

In the conventional cordless appliance, since the receiving means for receiving a signal sent from the sending means of the load section must be provided in the magnetism creating section, there is a problem that an IH cooking appliance which is already possessed by a consumer must be altered, or that a magnetism creating section thereof must be replaced with the magnetism creating section as disclosed in Patent Document 1.

Also, in the conventional cordless appliance, by utilizing a characteristic that a consumption power force is smaller for a large voltage of the primary coil in a condition that the load section is placed on the top plate, in comparison with a case where a pan is put on the top plate, the pan detection means determines a “no pan state”, and the sending means outputs a radio wave which is received by the receiving circuit, so that an operation of the inverter in the magnetism creating section is continued. When this condition is once set, the inverter, the rectifying smoothing circuit, the sending means and the receiving means are continuously operated. Thus, although the load section fails, the magnetism creating section continuously creates a high frequency magnetic field, so that an excess voltage is continuously applied to circuit elements of the load section. As a result, there is a problem that the circuit elements may be damaged or may burn due to the heating thereof.

Also, in the conventional cordless power source apparatus, since a receiving means for receiving a signal sent from a sending means provided in the coaster type adaptor must be provided in the primary coil unit, there is a problem that an IH cooking appliance which has already possessed by a consumer must be altered, or that a primary coil unit thereof must be replaced with the primary coil unit as disclosed in Patent Document 1.

Also, in the conventional cordless power source apparatus, when the condition, in which an electric power is not consumed due to the fact that a use of the cooking appliance is stopped, is continued over a predetermined period of time, energization of the primary coil is stopped. Nevertheless, as long as an electric power is consumed even when the coaster type adaptor or the cooking appliance fails, the primary coil unit continuously creates a high frequency magnetic flux, so that an excess voltage is continuously applied to circuit elements of the coaster type adaptor or the cooking appliance. As a result, there is a problem that the circuit elements may be damaged or may burn due to the heating thereof.

Especially, the IH cooking appliances which are prevailing at resent are very expensive. If these cooking appliances are equipped with a new control function such as a magnetism creating section as disclosed in Patent Document 1 or a primary coil unit as disclosed in Patent Document 2, they may become further expensive. Thus, except that such an expensive IH cooking appliance is freshly purchased, there is a problem that, in any case, it is impossible to take an inexpensive measure, and that it is not practical to replace a cooling appliance which is already possessed, and which is not frequently used.

Also, in the conventional cooling apparatus, an operation of the electronic cooling element and a direct current motor is stopped by removing the cooling apparatus from the electromagnetic induction heating apparatus. Thus, although the cooling apparatus fails, the electromagnetic induction heating apparatus continuously creates a high frequency magnetic field, so that an excess voltage is continuously applied to circuit elements of the cooling apparatus. As a result, there is a problem that the circuit elements may be damaged or may burn due to the heating thereof.

The present invention has been developed to solve the aforesaid problems, and a first object of the invention is to provide an electric power supply apparatus capable of supplying an electric power to a load such as a domestic electrified appliance by only putting it on a top plate of a powered-ON IH cooking appliance, without needing an electrical outlet and without any alteration of the IH cooking appliance which is already possessed in an ordinary home, and which is ordinarily used as a cooking heater.

Also, a second object of the present invention is to provide to an electric power supply apparatus which can prevent damage of circuit elements of a load such as an electrified appliance connected to the electric power supply apparatus, and burning of the circuit elements due to the heating thereof, even if the load fails.

### Means for Solving the Problems

An electric power supply apparatus according to the present invention comprises: a power generation coil that generates an induction current by crossing the power generation coil and an alternating magnetic field created by an induction heating cooking appliance, and that supplies it to a load; a breaker section connected between said power generation coil and said load; a detection section that detects physical quantities created in said power generation coil, said breaker section and/or said load; and a control section that controls an electrical disconnection between said power generation coil and said load based on signals output from said detection section, wherein, when a consumption power, which is consumed by said load when the electrical disconnection is established between said power generation coil and said load by said breaker section, falls outside a set range which is set by using as a standard a consumption power consumed by a magnetic material cooker put on said induction heating cooking appliance, said induction heating cooking appliance recognizes that the magnetic material cooker is not put thereon, to thereby stop the generation of the alternating magnetic field.

Also, an electric power supply apparatus according to the present invention comprises: a power generation coil that generates an induction current by crossing the power generation coil and an alternating magnetic field created by an induction heating cooking appliance, and that supplies it to a load; a dummy power consumption section that consumes said induction current in a quasi-manner; and a control section that controls a consumption power in said dummy power consumption section based on said induction current with respect to a set range which is set by using as a standard a consumption power consumed by a magnetic material cooker put on said induction heating cooking appliance, wherein, when a total consumption power, which is consumed by said load including said dummy power consumption section, falls outside said set range, said induction heating cooking appliance recognizes that the magnetic material cooker is not put thereon, to thereby stop the generation of the alternating magnetic field.

Also, if necessary, the electric power supply apparatus according to the present invention further comprises: a breaker section connected between said power generation coil and said load; and a detection section that detects physical quantities created in said power generation coil, said breaker section, said dummy power consumption section and/or said load, wherein said control section controls an electrical disconnection between said power generation coil and said load based on signals output from said detection section.

Further, if necessary, the electric power supply apparatus according to the present invention further comprises a control power generation section that generates constant voltages for said control section, wherein said control power generation section including a transformer connected between said power generation coil and said control section and stepping down a secondary voltage of the transformer to a primary voltage thereof, a diode bridge connected between said ormer and said control section and rectifying the alternating current from said power generation coil into a direct current, and a constant voltage circuit section connected between said diode bridge and said control section and supplying a constant voltage to said control section.

Also, in the electric power supply apparatus according to the present invention, if necessary, an induction current is generated in said power generation coil by intermittently emitting magnetic force lines from said induction heating cooking appliance during an initial operation of said induction heating cooking appliance, and said control section is started with constant voltages which are generated by said control power generation section based on said induction current.

### Effect of the Invention

The electric power supply apparatus according to the present invention comprises: a power generation coil that generates an induction current by crossing the power generation coil and an alternating magnetic field created by an induction heating cooking appliance, and that supplies it to a load; a breaker section connected between said power generation coil and said load; a detection section that detects physical quantities created in said power generation coil, said breaker section and/or said load; and a control section that controls an electrical disconnection between said power generation coil and said load based on signals output from said detection section, wherein, when a consumption power, which is consumed by said load when the electrical disconnection is established between said power generation coil and said load by said breaker section, falls outside a set range which is set by using as a standard a consumption power consumed by a magnetic material cooker put on said induction heating cooking appliance, said induction heating cooking appliance recognizes that the magnetic material cooker is not put thereon, to thereby stop the generation of the alternating magnetic field, whereby not only can the load such as an electrified appliance and so forth be supplied with an electric power by merely putting it on the induction heating cooking appliance without providing an electrical outlet in the top plate of the induction heating cooking appliance, but also it is possible to prevent circuits of the load from damaging or burning due to the heating thereof even if the electrified appliance connected to the electric power supply apparatus.

Also, the electric power supply apparatus according to the present invention comprises: a power generation coil that generates an induction current by crossing the power generation coil and an alternating magnetic field created by an induction heating cooking appliance, and that supplies it to a load; a dummy power consumption section that consumes said induction current in a quasi-manner; and a control section that controls a consumption power in said dummy power consumption section based on said induction current with respect to a set range which is set by using as a standard a consumption power consumed by a magnetic material cooker put on said induction heating cooking appliance, wherein, when a total consumption power, which is consumed by said load including said dummy power consumption section, falls outside said set range, said induction heating cooking appliance recognizes that the magnetic material cooker is not put thereon, to thereby stop the generation of the alternating magnetic field, whereby, although an consumption power of the load side including the load connected to the electric power supply apparatus falls outside the given range, the induction heating cooking appliance can recognize by a proper pan detection function thereof that a proper magnetic material cooker is put on a top plate of the induction heating cooking appliance, so that the induction heating cooking appliance can start a normal operation, to thereby establish an electric power source for the load.

Also, if necessary, the electric power supply apparatus according to the present invention further comprises: a breaker section connected between said power generation coil and said load; and a detection section that detects physical quantities created in said power generation coil, said breaker section, said dummy power consumption section and/or said load, wherein said control section controls an electrical disconnection between said power generation coil and said load based on signals output from said detection section, whereby, although a fault occurs in circuits elements, of which either an electrified appliance forming the load or the electric power supply apparatus, it is possible to automatically stop the induction heating cooking appliance, to thereby prevent an excess current from flowing into the circuits elements, of which either an electrified appliance forming the load or the electric power supply apparatus, and to thereby prevent the circuits of the load from damaging or burning due to the heating thereof.

Further, if necessary, the electric power supply apparatus according to the present invention further comprises a control power generation section that generates constant voltages for said control section, wherein said control power generation section including a transformer connected between said power generation coil and said control section and stepping down a secondary voltage of the transformer to a primary voltage thereof, a diode bridge connected between said transformer and said control section and rectifying the alternating current from said power generation coil into a direct current, and a constant voltage circuit section connected between said diode bridge and said control section and supplying a constant voltage to said control section, whereby it is possible to obtain a constant voltage from the induction current supplied from the power generation coil. Also, the power generation coil and the control section are isolated from each other by the transformer, and thus not only can damage of the control section based on spike noise be suppressed, but also the heating of the constant voltage circuit section can be suppressed.

Also, in the electric power supply apparatus according to the present invention, if necessary, an induction current is generated in said power generation coil by intermittently emitting magnetic force lines from said induction heating cooking appliance during an initial operation of said induction heating cooking appliance, and said control section is started with constant voltages which are generated by said control power generation section based on said induction current, whereby it is possible to determine whether a fault occurs in the circuit elements with magnetic force lines, which are continuously emitted from the induction heating cooking appliance when it proceeds to a normal operation, at the initial stage of the normal operation before heat is generated in a circuit element in which a fault occurs, so that the generation of heat can be prevented in the circuit element in which the fault occurs.

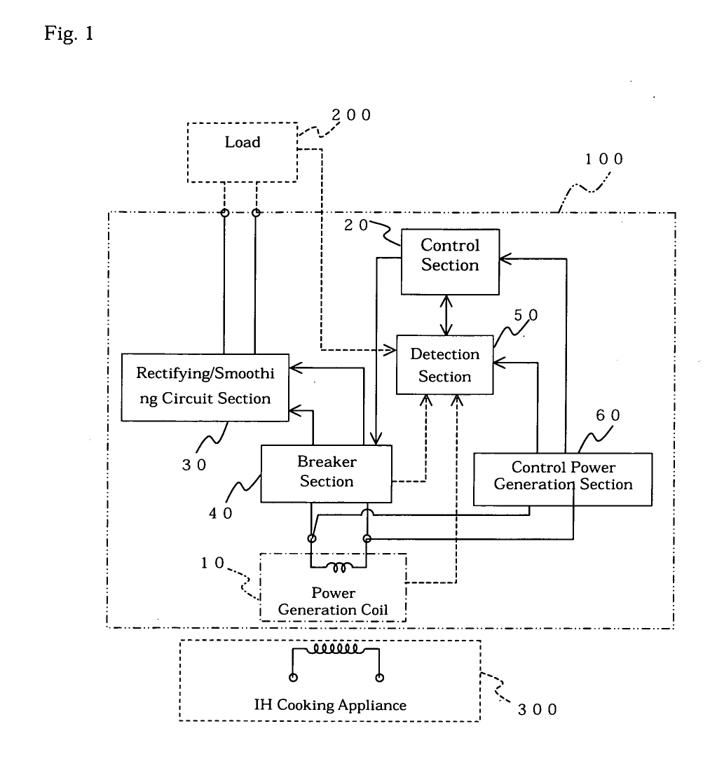

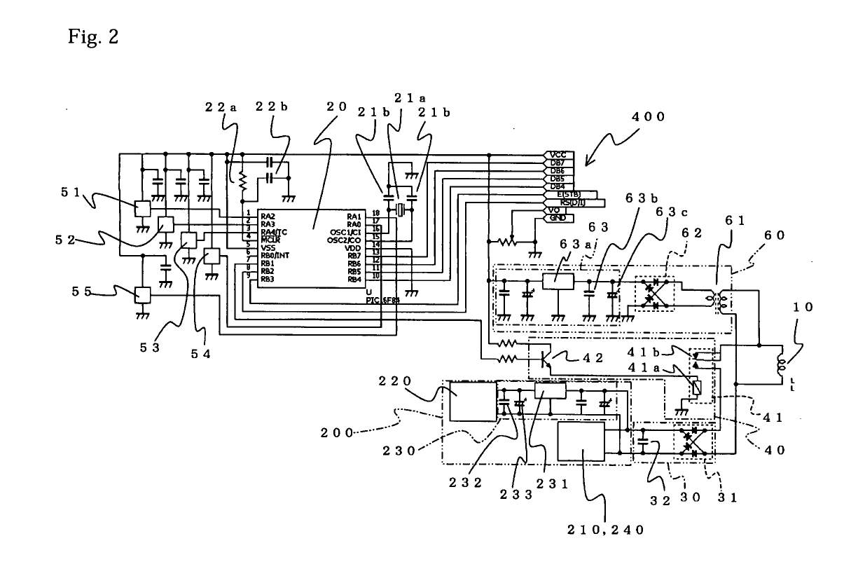

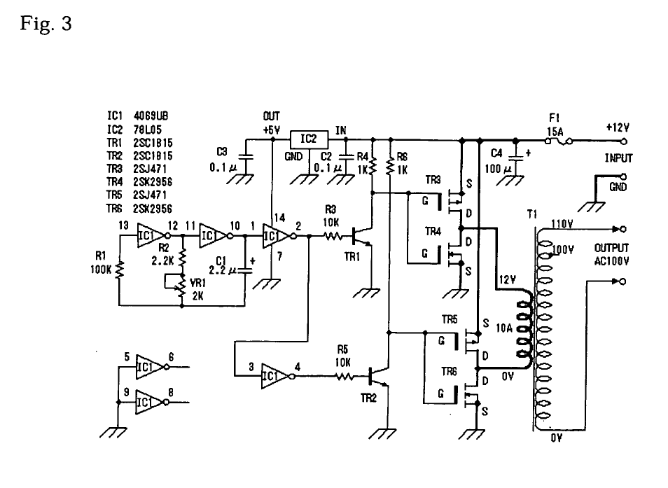

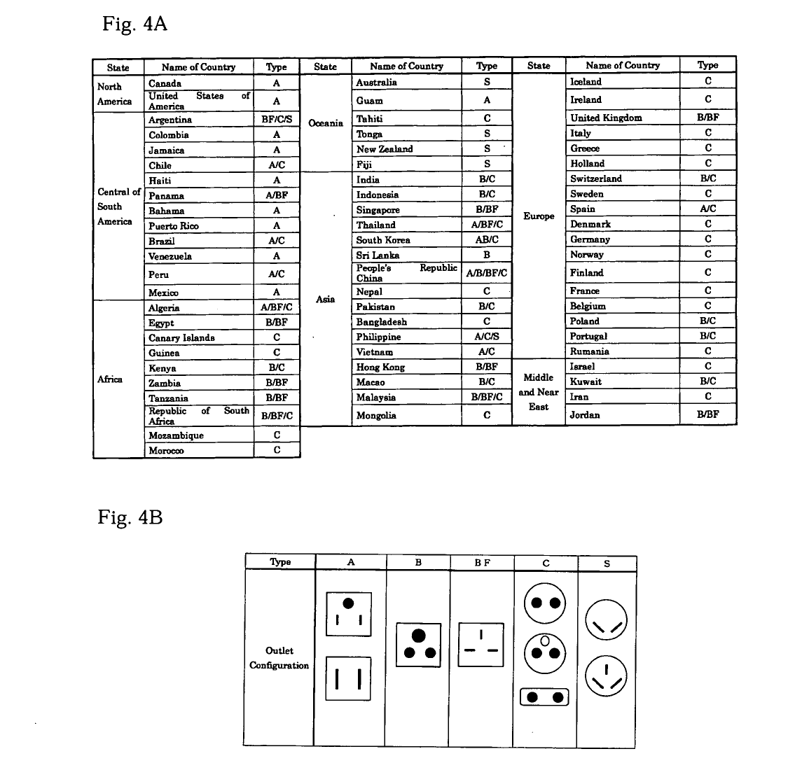

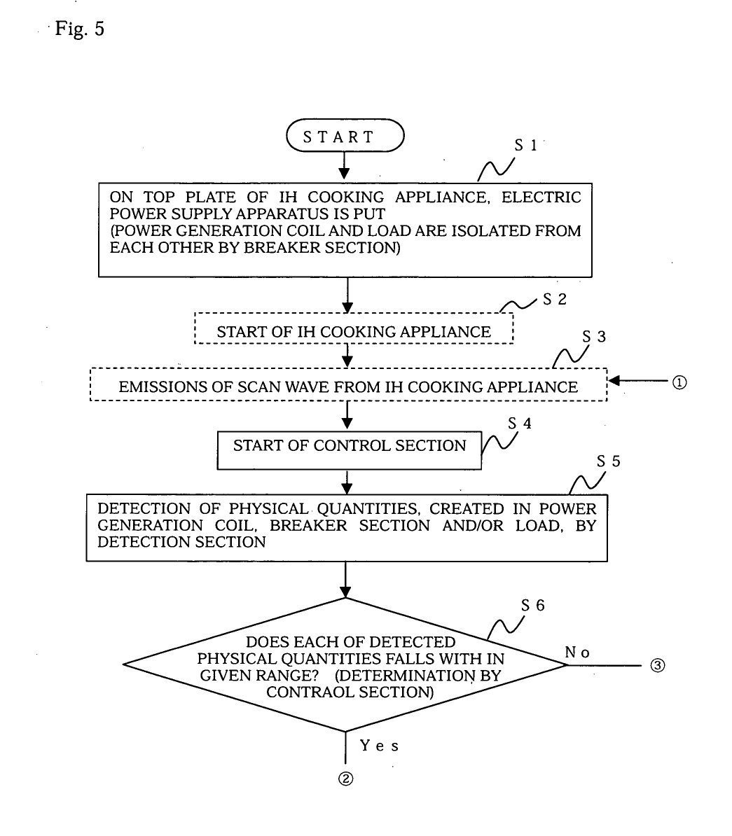

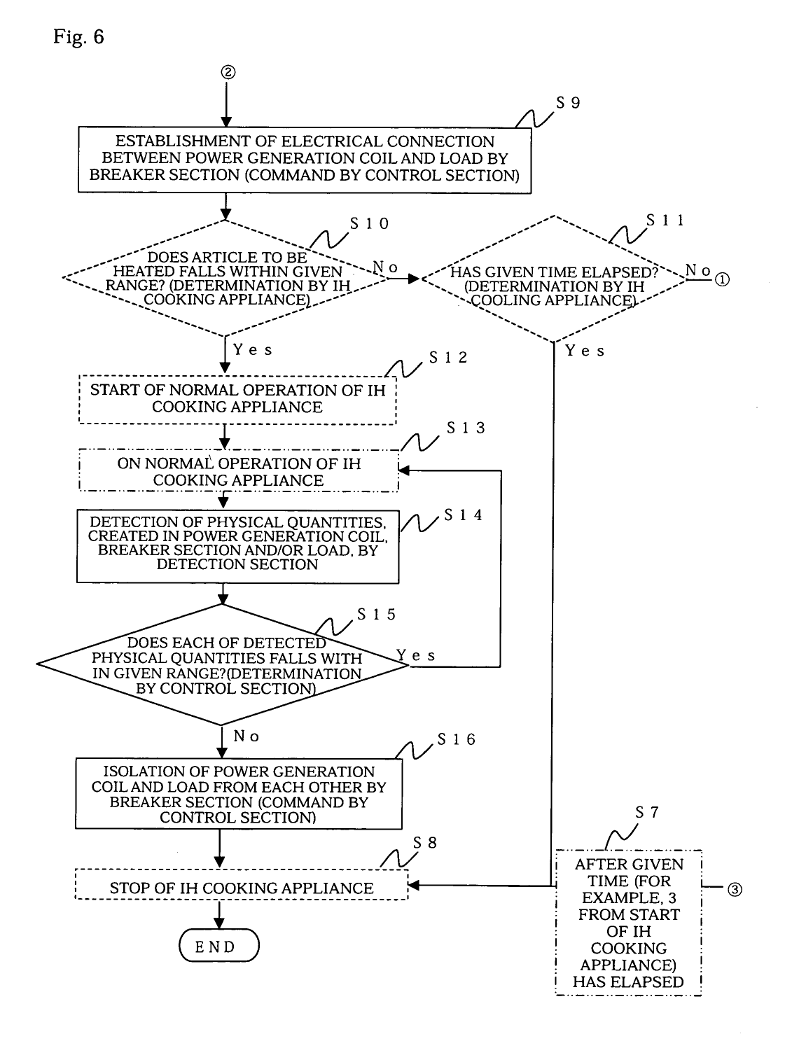

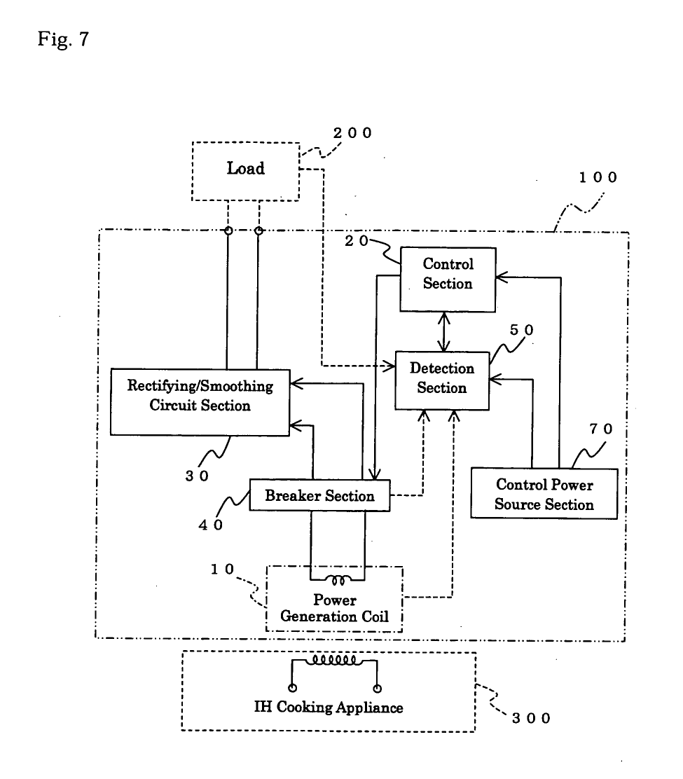

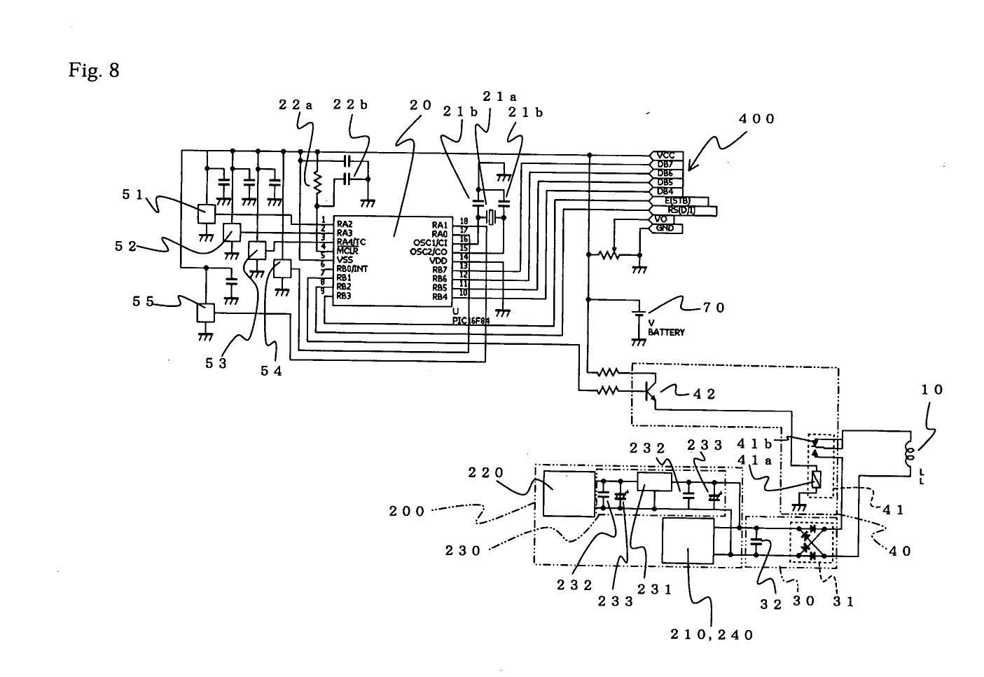

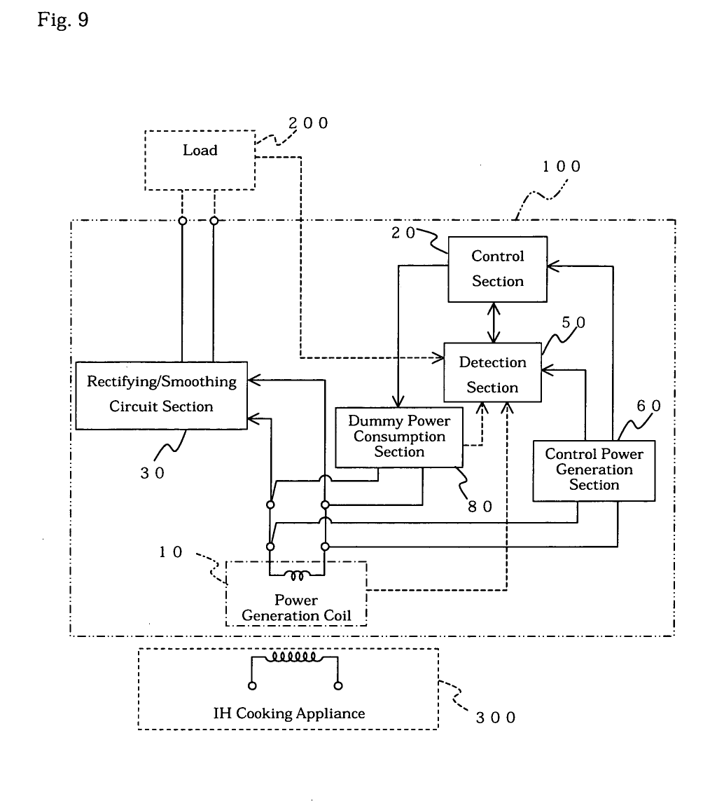

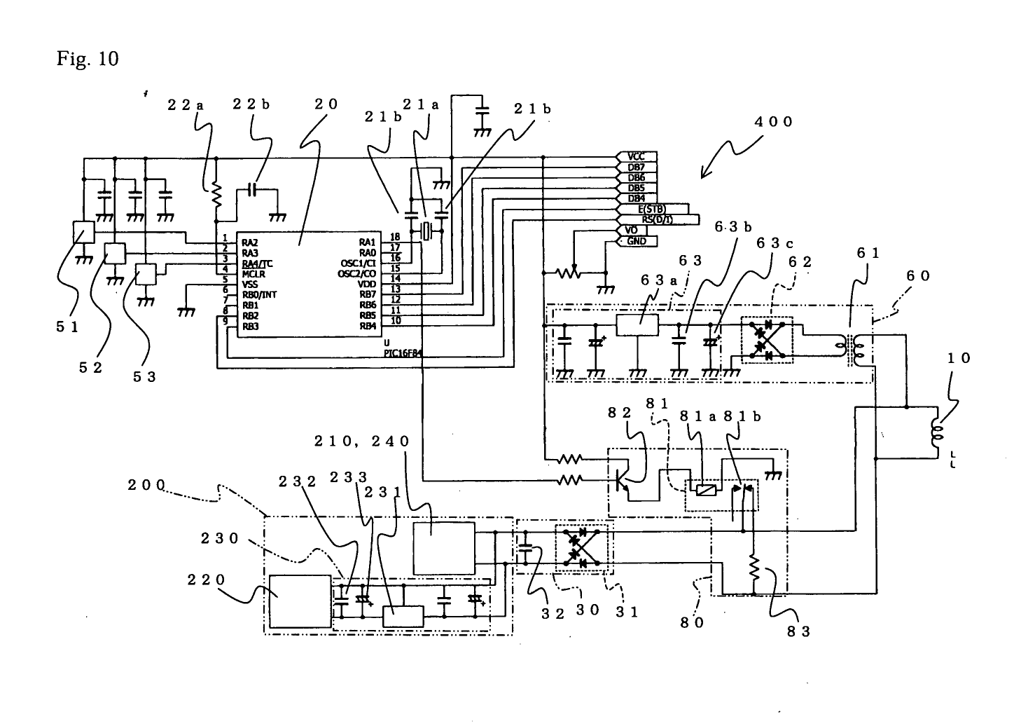

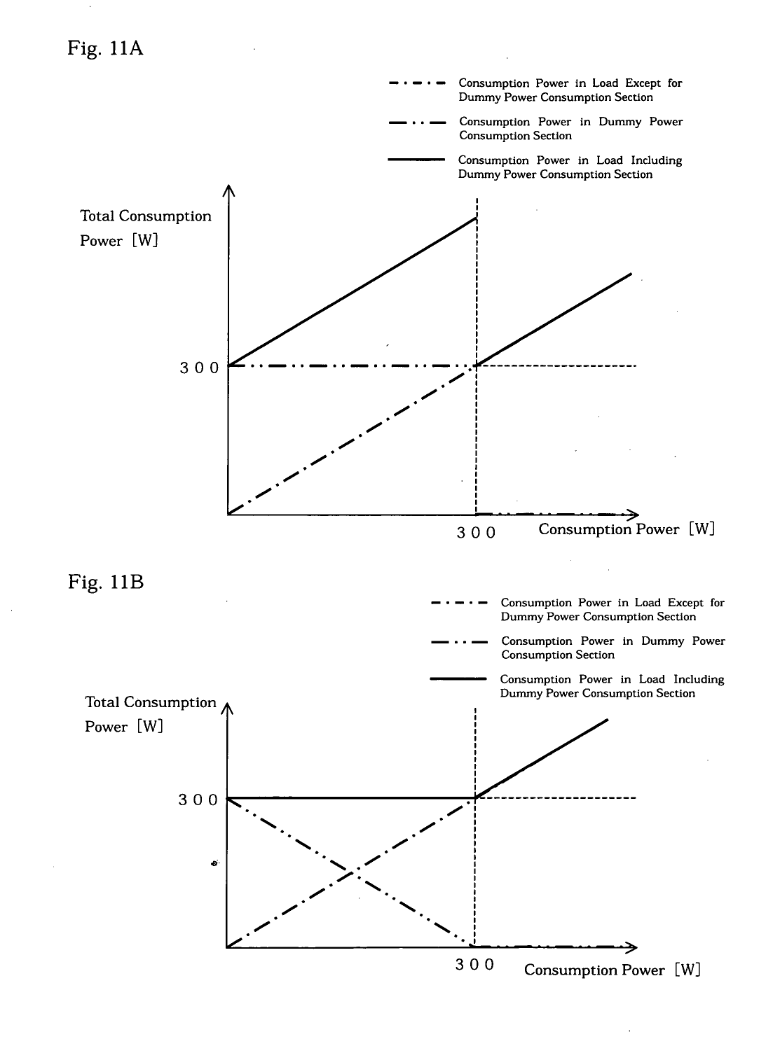

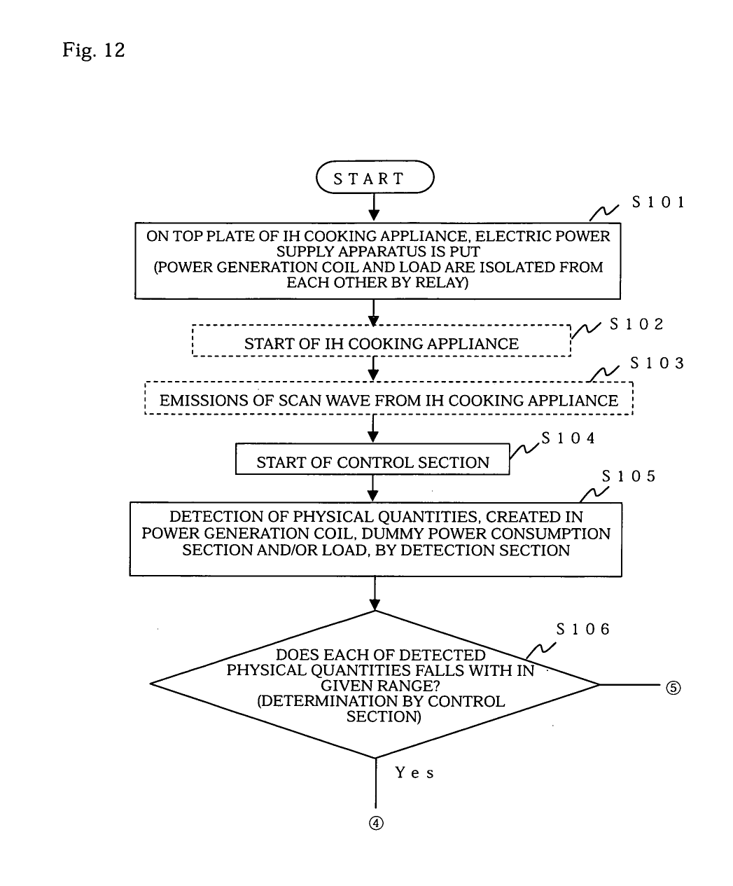

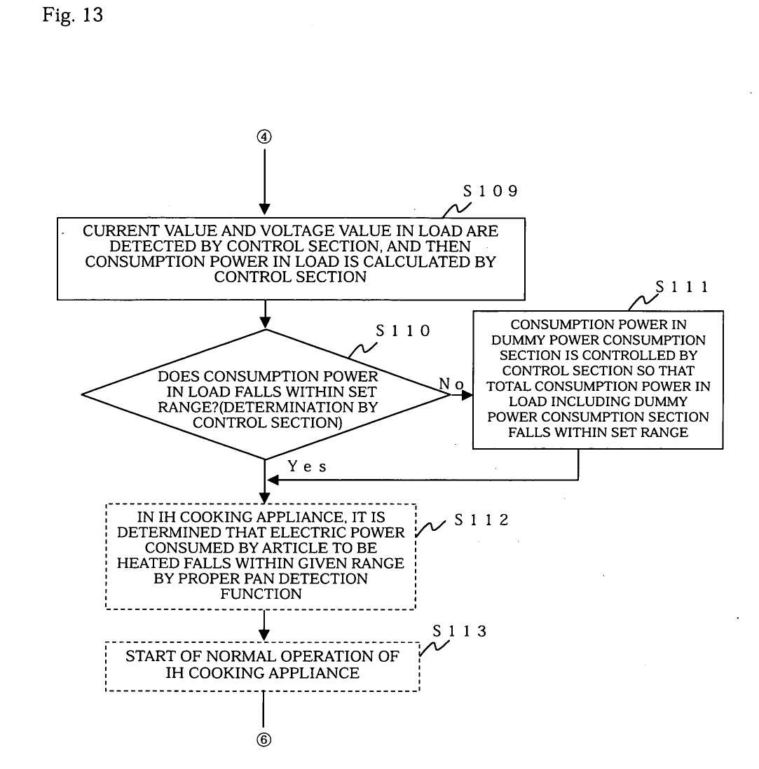

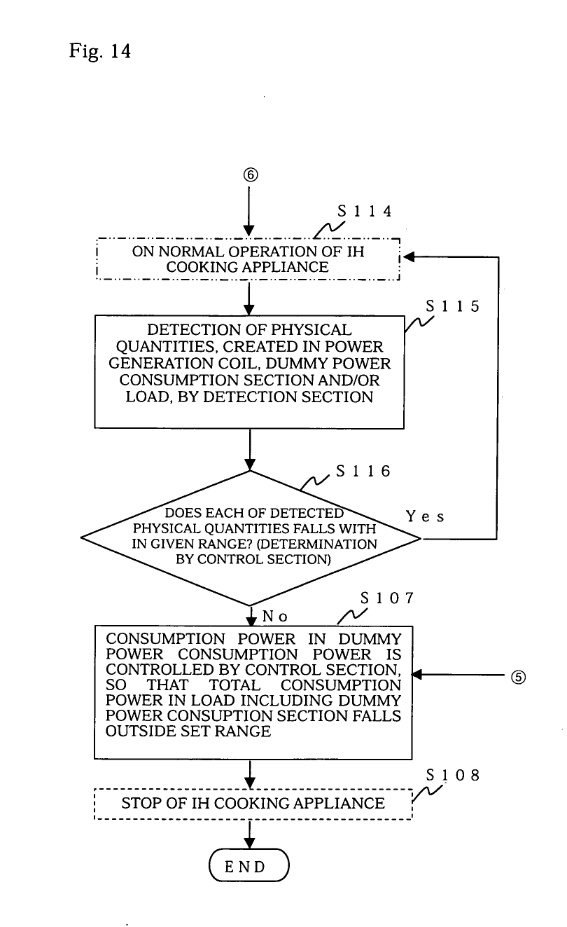

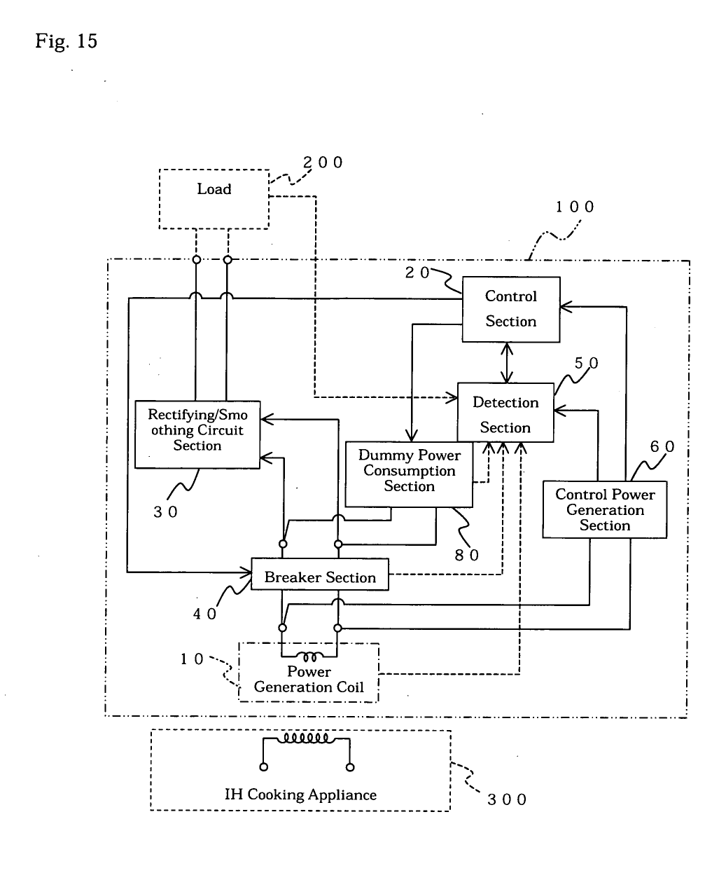

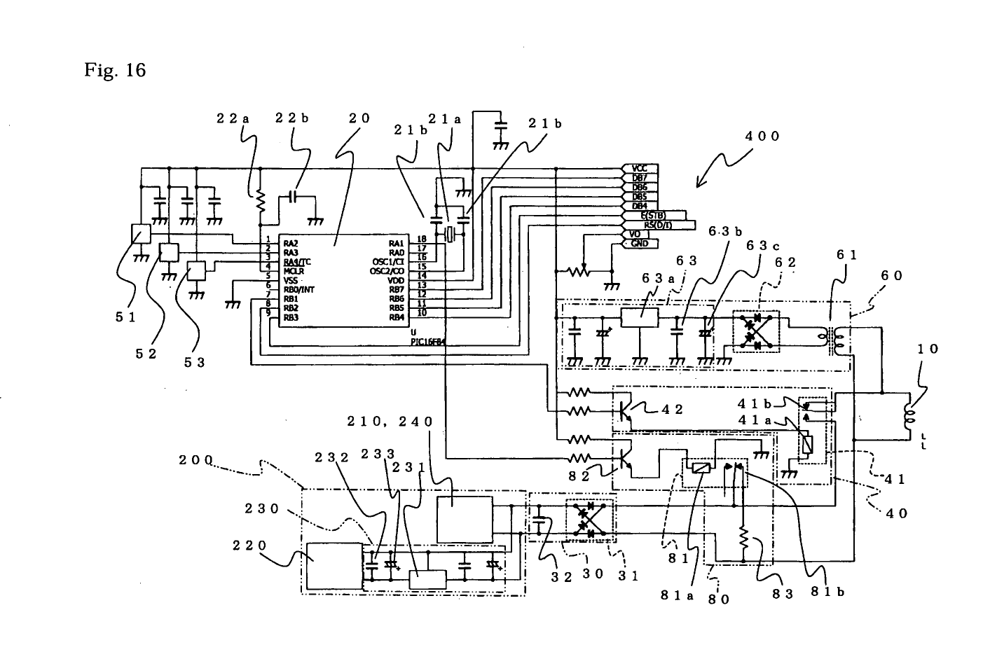

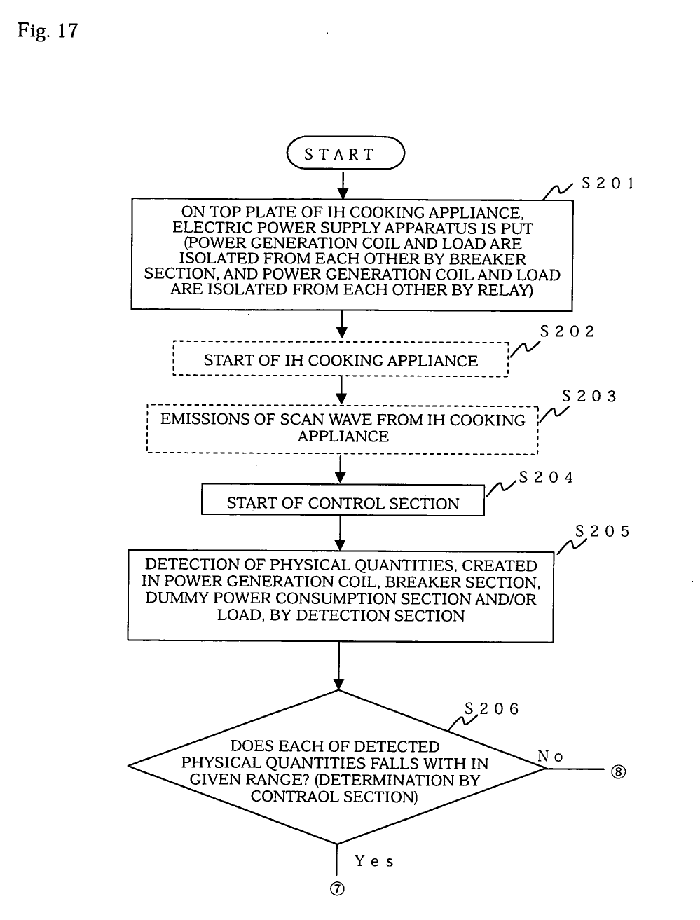

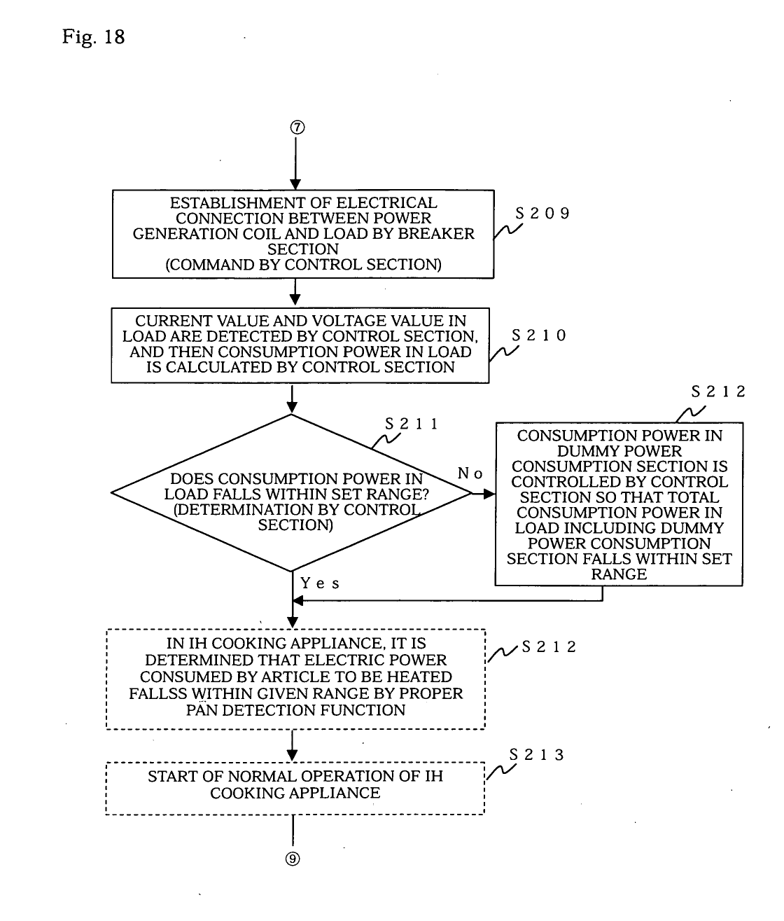

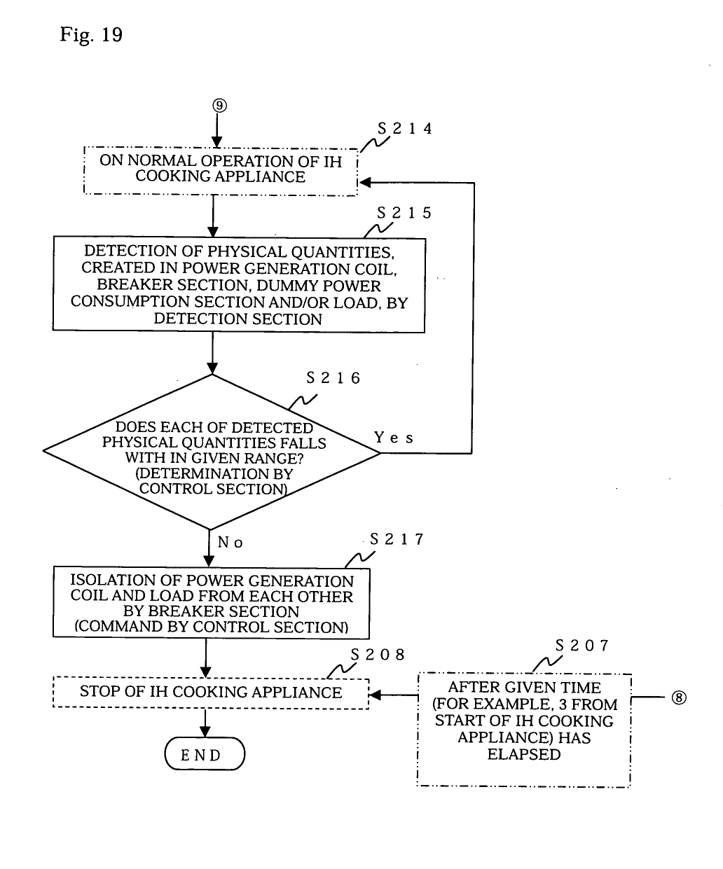

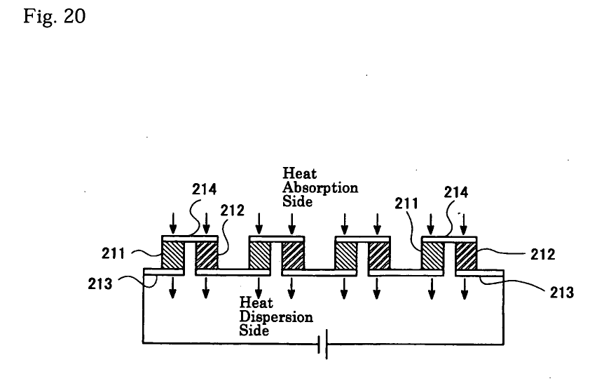

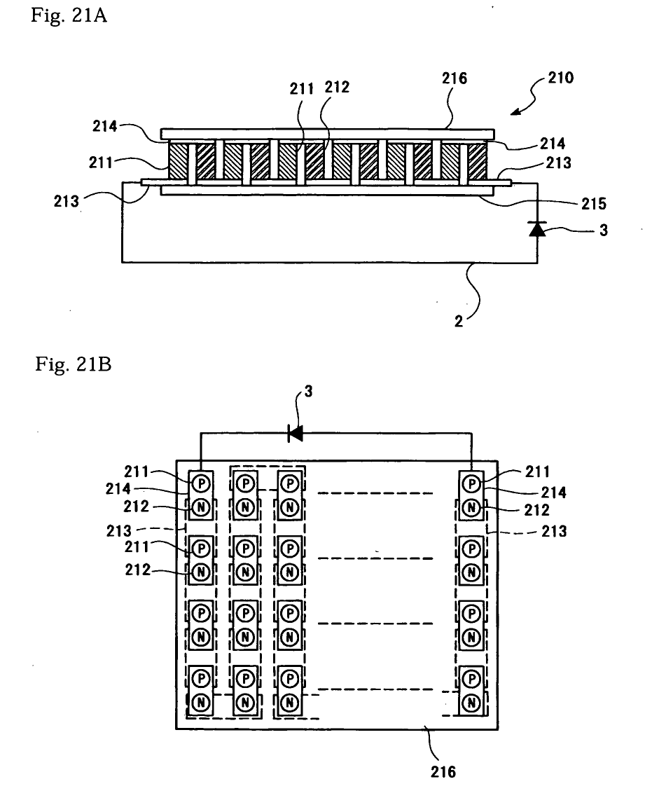

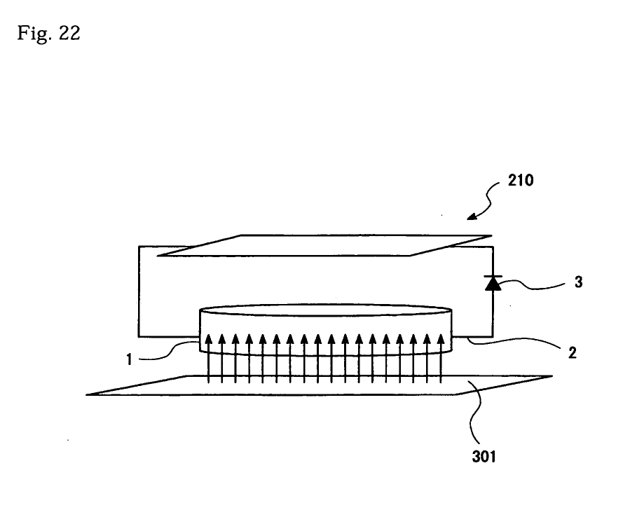

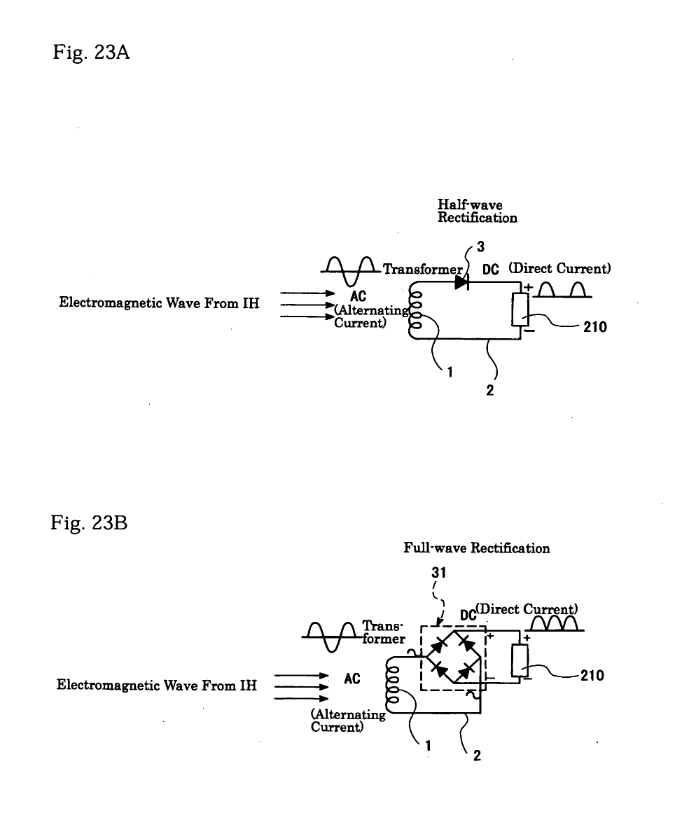

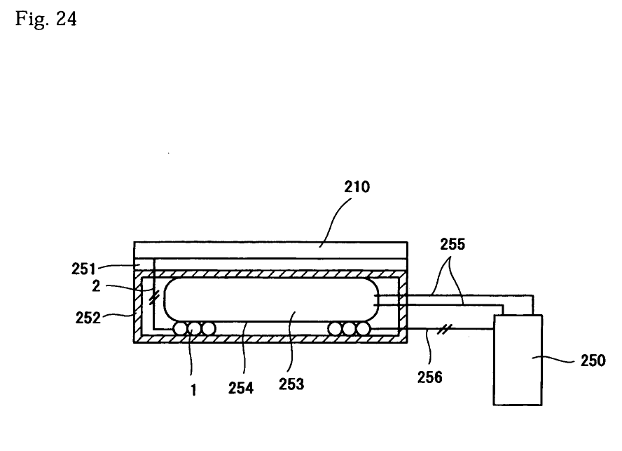

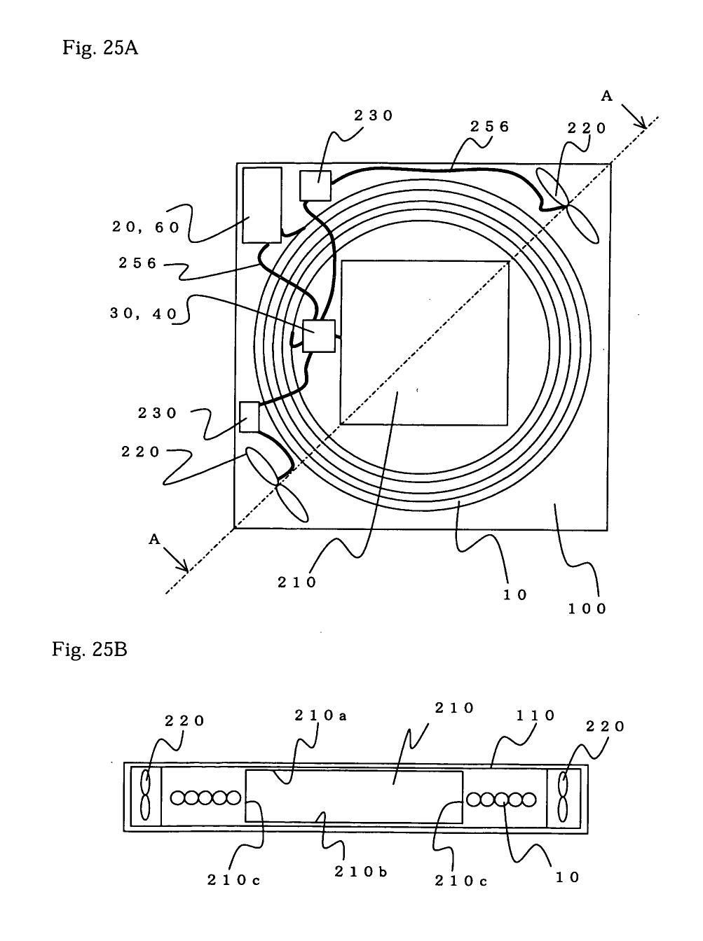

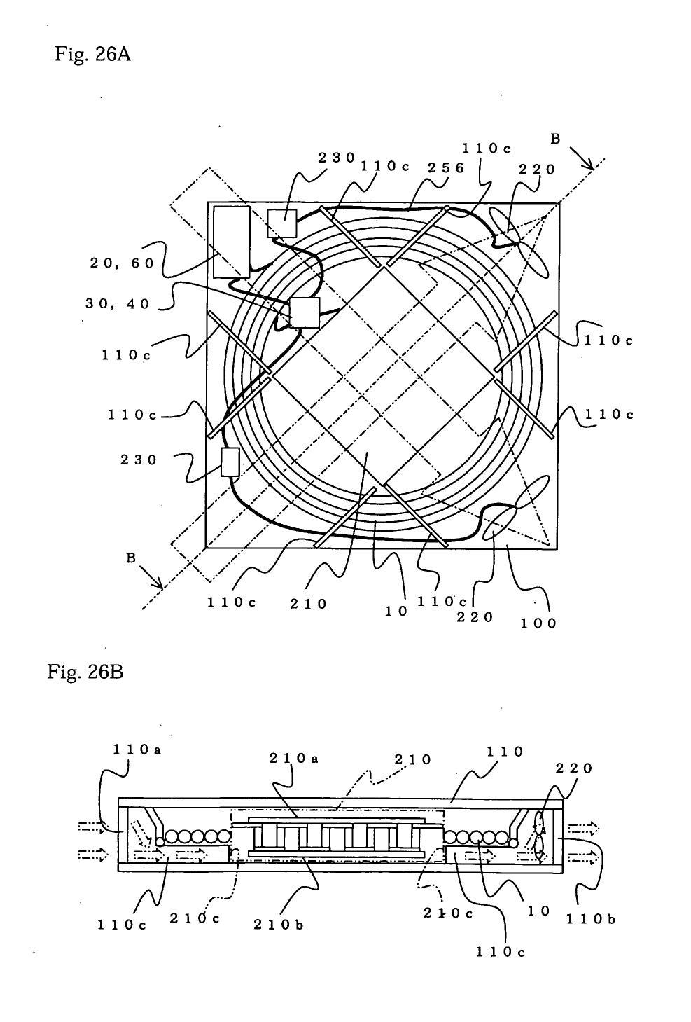

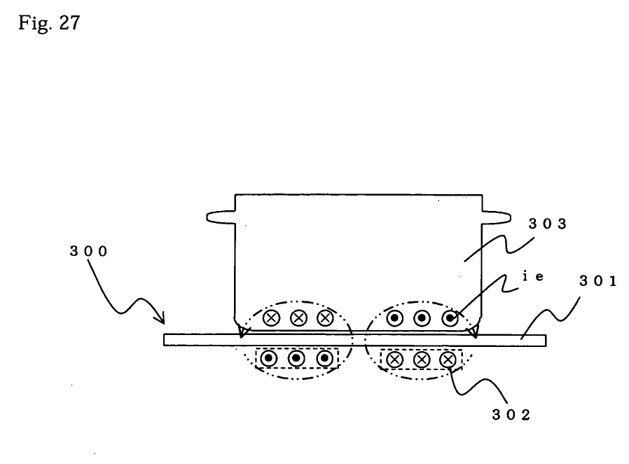

### BRIEF EXPLANATIONS OF DRAWINGS

[FIG. 1] is a conceptual view for explaining an electric power supply apparatus in a first embodiment for embodying the present invention.

[FIG. 2] is a circuit diagram showing an example of a concrete circuit arrangement of the electric power supply apparatus of FIG. 1.

[FIG. 3] is a circuit diagram showing an example of a DC-to-AC inverter.

[FIG. 4](a) is a table showing plug types, frequencies and voltages in respective foreign countries; and (b) is an explanatory view showing electrical outlet configurations corresponding to the respective plug types shown in FIG. 4(a).

[FIG. 5] is a flowchart for explaining an operation of the electric power supply apparatus of FIG. 1.

[FIG. 6] is the remaining part of the flowchart of FIG. 5.

[FIG. 7] is a conceptual view for explaining another electric power supply apparatus in the first embodiment for embodying the present invention.

[FIG. 8] is a circuit diagram showing an example of a concrete circuit arrangement of the electric power supply apparatus of FIG. 7.

[FIG. 9] is a conceptual view for explaining an electric power supply apparatus in a second embodiment for embodying the present invention.

[FIG. 10] is a circuit diagram showing an example of a concrete circuit arrangement of the electric power supply apparatus of FIG. 9.

[FIG. 11(a)] is a graph showing a relationship between a consumption power in a load and a consumption power in a dummy power consumption section on the condition that a power consumed by the dummy power consumption section is constant.

[FIG. 11(b)] is a graph showing a relationship between a consumption power in a load and a consumption power in a dummy power consumption section on the condition that a power consumed by the dummy power consumption section is variable.

[FIG. 12] is a flowchart for explaining an operation of the electric power supply apparatus of FIG. 9.

[FIG. 13] is a remaining part of the flowchart of FIG. 12.

[FIG. 14] is the remaining part of the flowchart of FIG. 13.

[FIG. 15] is a conceptual view for explaining an electric power supply apparatus in a third embodiment for embodying the present invention.

[FIG. 16] is a circuit diagram showing an example of a concrete circuit arrangement of the electric power supply apparatus of FIG. 15.

[FIG. 17] is a flowchart for explaining an operation of the electric power supply apparatus of FIG. 15.

[FIG. 18] is a remaining part of the flowchart of FIG. 17.

[FIG. 19] is the remaining part of the flowchart of FIG. 18.

[FIG. 20] is an explanatory view for explaining a principle of a Peltier module utilizing the Peltier effect.

[FIG. 21(a)] is a cross-sectional view showing a structure of the Peltier module.

[FIG. 21(b)] is a plan view showing a structure of the Peltier module.

[FIG. 22] is an explanatory view showing an operation principle of the Peltier module.

[FIG. 23(a)] is a circuit diagram showing an example for supplying the Peltier module with an electric power.

[FIG. 23(b)] is a circuit diagram showing another example for supplying the Peltier module with an electric power.

[FIG. 24] is a cross-sectional view showing a structure of a radiator for cooling a heat dispersion side of the Peltier module.

[FIG. 25(a)] is a plan view showing a schematic structure of an electric power supply apparatus which can be used as both a cooling apparatus and a heating apparatus by front and rear faces of the Peltier module.

[FIG. 25(b)] is a cross-sectional view of the electric power supply apparatus taken along the A-A line of FIG. 25(a).

[FIG. 26(a)] is a plan view showing a schematic structure of another electric power supply apparatus which can be used as both a cooling apparatus and a heating apparatus by front and rear faces of the Peltier module.

[FIG. 26(b)] is a cross-sectional view of the other electric power supply apparatus taken along the B-B line of FIG. 26(a).

[FIG. 27] is an explanatory view showing a principle of an IH cooking appliance.

### EXPLANATION OF REFERENCES

1 Coil
2 Conductor
3 Diode
10 Power Generation Coil
20 Control Section
21a Crystal Oscillator
21b Capacitor
22a Resister
22b Capacitor
30 Rectifying/Smoothing Circuit Section
31 Diode Bridge
32 Smoothing Capacitor
40 Breaker Section
41 Relay
41a Relay Coil
41b Switch Portion
42 Relay Driver Element
50 Detection Section
51 Voltage Sensor
52 Current Sensor
53 Temperature Sensor
54 Leakage sensor
55 Pressure sensor
60 Control Power Generation Section
61 Transformer
62 Diode bridge
63 Constant Voltage Circuit Section
63a 3-Terminal Regulator
63b Ceramic Capacitor
63c Electrolytic Capacitor
70 Control Power Source Section
80 Dummy Power Consumption Section
81 Relay
81a Relay Coil
81b Switch Portion
82 Relay Driver Element
83 Resistor
100 Electric Power Supply Apparatus
110 Housing
110a Inlet Port
110b Outlet Port
110c Partition Member
200 Load
210 Peltier Module
210a Heat Absorption Face
210b Heat Dispersion Face
210c Side Face
211 P-type Semiconductors
212 N-type Semiconductors
213 Electrode Plate
214 Electrode Plate
215 Ceramic Plate
216 Ceramic Plate
220 Fan
230 Constant Voltage Circuit Section
231 3-Terminal Regulator
232 Ceramic Capacitor
233 Electrolytic Capacitor
240 DC-to-AC Inverter
250 Radiator
251 Heat Radiation Plate
252 Casing
253 Cooling Medium
254 Container
255 Circulation Pipe
256 Electric Wire
300 IH Cooking Appliance
301 Top Plate
302 Magnetism Creating Coil
303 Magnetic Substance Cooker
400 Connecting Terminal

### THE BEST MODE FOR EMBODYING THE INVENTION

### First Embodiment of Present Invention

FIG. 1 is a conceptual view for explaining an electric power supply apparatus in a first embodiment for embodying the present invention; FIG. 2 is a circuit diagram showing an example of a concrete circuit arrangement of the electric power supply apparatus of FIG. 1; FIG. 3 is a circuit diagram showing an example of a DC-to-AC inverter; FIG. 4(a) is a table showing plug types, frequencies and voltages in respective foreign countries; FIG. 4(b) is an explanatory view showing electrical outlet configurations corresponding to the respective plug types shown in FIG. 4(a); FIG. 5 is a flowchart for explaining an operation of the electric power supply apparatus of FIG. 1; FIG. 6 is a remaining part of the flowchart of FIG. 5; FIG. 7 is a conceptual view for explaining another electric power supply apparatus in the first embodiment for embodying the present invention; FIG. 8 is a circuit diagram showing an example of a concrete circuit arrangement of the electric power supply apparatus of FIG. 7; and FIG. 27 is an explanatory view showing a principle of an IH cooking appliance.

First, a principle of an IH cooking appliance 300 will now be explained with reference to FIG. 27.

In the IH cooking appliance 300, a top plate 301 is made of heat-resistant glass or the like, and a magnetism creating coil 302 is arranged beneath the top plate, with the magnetism creating coil 302 being energized with a high frequency current so that an alternating magnetic field is created by the magnetism creating coil 302. When a cooking vessel (which is referred to as a magnetic material cooker 303 hereinafter) such as a pan, a kettle, a frying pan, a plate or the like, exhibiting a property of a magnetic material, is put on the top plate, eddy currents “ie” are induced in a bottom of the magnetic material cooker. The eddy currents “ie” flows in the electric resistance of the magnetic material forming the magnetic material cooker 303 to thereby generate Joule heat, and thus the bottom of the magnetic material cooker 303 is heated so that the heat is added to foodstuffs to be cooked, held in the magnetic material cooker 303.

Note, although, among types of the IH cooking appliance 300, there are a set-in type which is set in a built-in kitchen, an installed type (or an table type) which is suitable to a type of kitchen called a total kitchen, a 100 V desktop type which can be used in both a cooking in a family room, such as a hot pot cooking, a meat-grill cooking or the like, and a cooking in a kitchen, and so forth, the IH cooking appliance 300 used in an electric power supply apparatus 100 according to the present invention is especially not limited to only any one of these types. Also, although the IH cooking appliance 300 prevailing at present feature a standard electric power of 2 kW, there are a type such as a desktop type featuring a maximum electric power of 1.2 kW, and another type having a high output burner featuring an electric power falling within a range from 2.5 kW to 3 k, which is suitable to not only steel but also all metals such as copper, aluminum and so forth.

Also, the prevailing IH cooking appliance 300 is generally equipped with a proper pan detection function. This proper pan detection function is to detect that an article to be heated is put on the top plate 301 as the proper magnetic material cooker 303, which is not a cooking appliance unable to be used in the IH cooking appliance 300 or a small article such as a knife, a fork, a spoon or the like, in a case where an electric power consumed by the article to be heated falls within a given range when the article to be heated is irradiated with intermittent magnetic force lines which are defined as a scan wave having constant energy (The given range varies in accordance with a type of the IH cooking appliance 300, and, at present, there is a variety of IH cooking appliances 300 in which a range to be set for detecting the proper magnetic material cooker 303 made of steel has a low limit falling within a range from 250 W to 400 W. For easy understanding of the present invention, the explanation is made hereinafter on assumption that the range for detecting by the IH cooking appliance 300 that the proper magnetic material cooker 303 is put on the top plate is defined by a low limit of at least 300 W.). Thus, when it is detected by the IH cooking appliance 300 that the proper magnetic material cooker 303 is put on the top plate 301, an ordinary operation is carried out in the IH cooking appliance 300 so that the article to be heated is irradiated with continuous magnetic force lines.

In the present invention, the alternating magnetic field created by the magnetism creating coil 302 of the IH cooking appliance 300 crosses a power generation coil 10 to thereby generate an electric current in the power generation coil 10 which serves as a power source for supplying an electric power to a load side.

In FIGS. 1 and 2, the power generation coil 10 is a coil formed by winding twisted enamel wires (Litz wires) in a plane, which are produced by coating several tens of soft copper wires with an insulating enamel, by baking them, and by twisting them, and the alternating magnetic field created by the magnetism creating coil 302 of the IH cooking appliance 300 crosses the coil to thereby generate an induction current in the coil, so that a load 200 and/or a control section 20 are supplied with the induction current. Note, in this first embodiment, since a strength of the alternating magnetic field created by the magnetism creating coil 302 of the IH cooking appliance 300 features a degree which is suitable to heat steel, it is possible to suppress a heat generation in the power generation coil 10 made of copper.

When the electric power supply apparatus 100 is used as a cooling apparatus, the load 200 includes a below-mentioned Peltier module 210 composed of Peltier elements, a fan 220 for cooling a heating side of the Peltier module 210, and a constant voltage circuit section 230 forming a constant voltage power supply for the fan 220. Also, when the electric power supply apparatus 100 is used as a heat generating apparatus, the load 200 includes not shown Nichrome wires. Note, when the electric power supply apparatus 100 is used as the heat generating apparatus, the fan 220 for cooling the Nichrome wires and the constant voltage circuit section 230 are unnecessary.

Further, in a case where the electric power supply apparatus 100 is used as a power source apparatus, since an alternating current induced by the power generation coil 10 features several thousands of hertz, it is necessary to convert the alternating current into one featuring a frequency of 50 Hz or 60 Hz and a voltage of 100 V before the electric power supply apparatus 100 can be used to operate ordinary electrified appliances in Japan.

Accordingly, when the electric power supply apparatus 100 is used as the power source apparatus, the load 200 includes a not shown electrical appliance connected to the electric power supply apparatus 100 through an attachment such as an electrical outlet, a connector, a socket or the like, a DC-to-AC inverter 240 by which the current induced by the power generation coil 10 is converted into one featuring a frequency and a voltage for operating the electrified appliance, a fan 220 for cooling the DC-to-AC inverter 240, and the constant voltage circuit section 230 forming the constant voltage power supply for the fan 220. Although a circuit configuration as shown, for example, in FIG. 3 may be considered as the DC-to-AC inverter 240 outputting the voltage of 100 V, the DC-to-AC inverter cannot be not limited to only this circuit configuration.

Note, domestic electrified appliances prevailing in Japan are used by inserting a plug in a plug receiver of a wiring connector, i.e., an electrical outlet wiring an ordinary domestic 100 V outlet GIS C 8303 bipolar outlet 15 A 125 V). Nevertheless, as shown in FIG. 4, in foreign countries, there is a variety of electrical outlet configurations, and there are a plug, a frequency and a voltage corresponding to each of the electrical outlet configurations. Thus, when the electric power supply apparatus 100 is used, it is preferable to carry out a selection of a configuration of an electrical outlet, which is an attachment of the electric power supply apparatus, and a design of a circuit of the DC-to-AC converter 240 in accordance with specifications of an electrified appliance connected to the electric power supply apparatus 100.

The constant voltage circuit section 230 includes a constant voltage circuit using a 3-terminal regulator 231, an oscillation preventing ceramic capacitor 232 featuring a capacitance falling within a range from 0.01 to 0.1 μF and provided at an input terminal of the 3-terminal regulator 231, and a smoothing electrolytic capacitor 233 featuring a capacitance falling within a range from 100 to 1000 μF and provided at an output terminal of the 3-terminal regulator 231.

A rectifying/smoothing circuit section 30 is connected in parallel between the power generation coil 10 and the load 200, and includes a diode bridge 31 which is composed of four rectifier elements to thereby rectify the current induced by the power generation coil 10, i.e., the alternating current into a direct current, and a smoothing capacitor 32 by which a pulsating current included in the voltage output from the diode bridge 31. That is to say, the diode bridge 31 is connected in parallel to the power generation coil 10, and the smoothing capacitor 32 is connected in parallel between the diode bridge 31 and the load 200. Also, a below-mentioned breaker section 40 is connected between the power generation coil 10 and the rectifying/smoothing circuit section 30.

Note, if an electrified appliance, which is operated with the high frequency current induced by the power generation coil 10, is connected as the load 200 to the electric power supply apparatus 100, the rectifying/smoothing circuit section 30, the

DC-to-AC inverter 240 and the fan 220 are unnecessary.

A detection section 50 detects respective physical quantities created in the power generation coil 10, the breaker section 40 and/or the load 200, converts the detected physical quantities into corresponding signals, and then inputs the signals to the control section 20. Note, in the detection section 50, one of a voltage sensor, a current sensor, a temperature sensor, a leakage sensor, a pressure sensor, a photo-sensor, a moisture sensor, an inclination sensor, a gas/odor sensor and so forth is used, or at least two of these sensors are suitably combined.

Note that there is a possibility that a sensor in the detection section 50 is not properly operated because the magnetic force lines emitted from the IH cooking appliance 300 may be regarded as a mass of noise. Also, a small amount of induction current flows between the IH cooking appliance 300 and an article put thereon, resulting in occurrence of a leakage therebetween. For this reason, although the power generation coil 10, the breaker section 40 and/or the load 200 are normal, it is necessary to determine whether a physical quantity detected by a sensor is caused by leakage or by abnormality.

Accordingly, it is preferable that some kinds of sensors used in the detection section 50 are combined with each other because, by detecting some physical quantities created in the power generation coil 10, the breaker section 40 and/or the load 200, it is properly determine respective states of the power generation coil 10, the breaker section 40 and/or the load 200 based on some conditions.

Especially, it is preferable to use at least a leakage sensor and a temperature sensor in the detection section 50, and it is further preferable to provide a leakage sensor in an electrified appliance forming the load 200 when the temperature sensor cannot be provided in the electrified appliance forming the load 200 due to a package thereof.

Note that a temperature sensor provided in the prevailing IH cooking appliance 300 is to detect a temperature of more than 300° C. for a tempura cooking and so forth, and thus it cannot detects a heating state of less than 300° C. in the power generation coil 10 of the electric power supply apparatus 100 put on the IH cooking appliance 300. For this reason, the temperature sensor used in the detection section 50 is to detect a temperature falling within a range which cannot be detected by the temperature sensor of the IH cooking appliance 300 (i.e., which is less than a set temperature of the temperature sensor of the IH cooking appliance 300).

In the control section 20, on the basis of a signal input from the detection section 50, a physical quantity detected by the detection section 50 is compared with a reference value, whereby either a rest state of the electrified appliance forming the load 200 (i.e., a turn-OFF state caused by a power switch or a timer function of the electrified appliance) or an abnormal state occurring in the power generation coil 10, the breaker section 40 and/or the load 200 is determined so that the power generation coil 10 is isolated from the load side by controlling the breaker section 40. Note that the reference value cannot be set as a fixed value because an output of the IH cooling appliance varies in accordance with a type thereof, and also a number of magnetic force lines, spaces therebetween, wave shapes thereof and so forth are different. For this reason, in the control section 20, the reference value is suitably set based on the magnetic force lines emitted from the IH cooling appliance 300, and thus a control is carried out.

In the control section 20, a microcomputer (which is referred to as a micom) may be used. In this first embodiment, is used PIC16F84 which is one chip micom selected from representative PIC (Peripheral Interface Controller) middle range series variable from Microchip Technology Inc., which features a low power consumption and a low price, and which is operable by a battery.

PIC contains a circuit for stably oscillating a stable clock signal, and can be easily used by merely connecting minimum parts for determining a frequency of the clock signal thereto. For a representative means for oscillating the clock signal, there are an RC oscillation, a ceramic oscillator and a crystal oscillator, and, in FIG. 2, a crystal oscillator 21a is connected to OSC1/CLKOUT (Pin Number 15) and OSC2/CLIKIN (Pin Number 16) of IPC which are oscillator terminals thereof. Also, two capacitors 21b having a capacitance falling in a range from 15 to 33 pF to the crystal oscillator 21a, with a middle therebetween being grounded.

Also, it is necessary to supply PIC with a direct voltage before PIC can be operated, and an operating voltage of PIC16F84 falls within a range from 2 to 6 V. For this reason, a voltage suitable to an operation of PIC is produced by a below-mentioned control power generation section 60 from the induction current created by the power generation coil 10, and is input to VDD (Pin Number 14) of PIC which is a power supply terminal thereof. Further, VSS (Pin Number 5) of PIC which is GND thereof is grounded.

Although PIC is supplied with the direct voltage, a rated voltage cannot be immediately obtained, and, in this transition, an operation of PIC is started in an unstable condition. In order to resolve this problem, there is a measure in which PIC is operated by supplying MCLR of PIC, which is a reset terminal thereof, with an output voltage of an integrated, circuit composed of a resistor 22a and a capacitor 22b, through the intermediary of a small resistor (from 100 to 1000Ω).

Also, in this first embodiment, the detection section 50 is provided with a voltage sensor 51, a current sensor 52, a temperature sensor 53, a leakage sensor 54 and a pressure sensor 55; the voltage sensor 51 is connected to RA2 (Pin Number 1) of PIC which is an I/O port A (bit 2) thereof; the current sensor 52 is connected to RA3 (Pin Number 2) of PIC which is an I/O port A (bit 3) thereof; the temperature sensor 53 is connected to RA4/TOCKI (Pin Number 3) of PIC which is an I/O port A (bit 4) thereof; the leakage sensor 54 is connected to RA0 (Pin Number 17) of PIC which is an I/O port A (bit 0) thereof; and the pressure sensor 55 is connected to RA1 (Pin Number 18) of PIC which is an I/O port A (bit 1) thereof. For respective power supply sources to the voltage sensor 51, the current sensor 52, the temperature sensor 53, the leakage sensor 54 and the pressure sensor 55, a constant voltage is produced by the below-mentioned control power generation section 60 from the induction current created by the power generation coil 10, and are applied to the respective sensors.

Also, in the electric power supply apparatus 100 of this first embodiment, a display apparatus such as a liquid crystal display apparatus or the like, which is not necessarily needed, may be connected to the control section 20 to thereby display information and so forth displaying showing an operation state of the electric power supply apparatus 100 on the display apparatus. In this case, respective connecting Terminals 400 of the liquid crystal display apparatus are connected to RB1 to RB7 (Pin Numbers 7 to 13) of PIC which are I/O ports B (bit 1 to bit 7) thereof.

The control power generation section 60 includes a transformer 61 connected between the power generation coil 10 and the control section 20 and stepping down a secondary voltage of the transformer 61 (e.g., 10 V) to a primary voltage thereof (e.g., 600 to 800 V), a diode bridge 62 connected between the transformer 61 and the control section 20 and rectifying the alternating current from the power generation coil 10 into a direct current, and a constant voltage circuit section 63 connected between the diode bridge 62 and the control section 20 and supplying a constant voltage to the control section 20. Note that the circuits of the control section 20 connected to the power generation coil 10 through the control power generation section 60 are arranged so as to branch from a middle between the below-mentioned breaker section 40 and the power generation coil 10 in the circuits of the load connected to the power generation coil 10.

The constant voltage circuit section 63 includes a constant voltage circuit using a 3-terminal regulator 63a, an oscillation preventing ceramic capacitor 63b featuring a capacitance falling within a range from 0.01 to 0.1 μF and provided at an input terminal of the 3-terminal regulator 63a, and a smoothing electrolytic capacitor 63c featuring a capacitance falling within a range from 100 to 1000 μF and provided at an output terminal of the 3-terminal regulator 63a.

The transformer 61 isolates the power generation coil 10 and the micom forming the control section 20 from each other, whereby damage of the micom caused by spike nose can be suppressed.

Also, in the 3-terminal regulator 63a, since a difference between input and output voltages and a product of current directly causes heat generation in the elements of the regulator, the transformer 61, which can basically step down a voltage without heat generation, is intervened between the 3-terminal regulator 63a and the power generation coil 10. In short, although it is considered that a resistor may be substituted for the transformer 61 to step down the voltage, the resistor generates heat, and thus it is preferable to use the transformer 61.

Also, by intervening the transformer 61 between the power generation coil 10 and the constant voltage circuit section 63, inexpensive circuit elements, which are susceptible to noise, can be used in the constant voltage circuit section 63, whereby it is possible to suppress a cost of the constant voltage circuit section 63.

Note, if the constant voltage circuit section 63 could be improved in performance (small heat generation), and if the constant voltage circuit section 63 could output a constant voltage even when spark noise are input to the constant voltage circuit section, it is considered that the transformer 61 is omitted. However, at present, there is not the constant voltage circuit section 63 featuring such superior performance, and thus it is common that the constant voltage circuit section 63 is cooled by the fan so that the temperature is lowered to less than 300° C. at which solder cannot be melted.

The breaker section 40 is connected to the power generation coil 10 so that the circuits of the control section 20 connected to the power generation coil 10 through the control power generation section 60 are put therebetween, and is controlled by the control section 20 based on a signal output from the detection section 50. For this reason, although the power generation coil 10 and the load 200 are isolated from each other by the breaker section 40, the control section 20 is always supplied with the induction current created by the power generation coil 10 as long as the IH cooling appliance 300 is operated.

Note, in this first embodiment, the breaker section 40 uses a relay 41, and contacts of a switch portion 41b are opened and closed by a relay coil 41a. Also, for the supply of current to the relay coil 41a to make it function as an electromagnet for attracting the switch portion 41b, an NPN bipolar transistor is used as a relay driver element 42. Also, a base of the NPN bipolar transistor forming the relay driver element 42 is connected to PB1 (Pin Number 7) of PIC forming the control section 20, which is I/O port B (bit 1) thereof; a collector of the NPN bipolar transistor is connected to an output side of the control power generation section 60; and an emitter of the NPN bipolar transistor is connected to the relay coil 41a.

Also, as shown in FIG. 2, the switch portion 41b is connected in series between one terminal of the power generation coil 10 and one terminal of the diode bridge 31. For this reason, when the power generation coil 10 and the load 200 are isolated from each other by the switch portion 41b, impedance of the load 200 is infinite so that the induction current cannot flow into the load 200, and only the control section 20 is supplied with the induction current. Nevertheless, since impedance of the transformer 61 is very large, a small current on the order of 0.1 A merely flows into the transformer 61. In particular, since power consumption of the control section 20 is very small, the IH cooking appliance 300 recognizes that the proper magnetic material cooker 303 is not put on the top plate 301 by the proper pan detection function thereof, and thus the operation of the IH cooking appliance is stopped.

Note, in this first embodiment, although the switch portion 41b of the relay 41 is connected in series between the one terminal of the power generation coil 10 and the one terminal of the diode bridge 31, it may be connected in series between the one terminal of the power generation coil 10 and the one terminal of the diode bridge 31 and between the other terminal of the power generation coil 10 and the other terminal of the diode bridge 31.

Also, the switch portion 41b of the relay 41 may be connected in parallel between the power generation coil 10 and the diode bridge 31. In this case, it is necessary to reverse an open/close timing of the contacts of the switch portion 41b which is connected in series between the one terminal of the power generation coil 10 and the one terminal of the diode bridge 31.

In particular, in the control section 20, on the basis of a signal input from the detection section 50, a physical quantity detected by the detection section 50 is compared with a reference value, whereby either a rest state of the electrified appliance forming the load 200 or an abnormal state occurring in the power generation coil 10, the breaker section 40 and/or the load 200 is determined so that the contacts of the switch portion 41b forming the breaker section 40 is closed to thereby short-circuit the power generation coil 10. Accordingly, a resistance of the load 200 is made to be 0Ω so that no power is consumed by the load 200, and thus the IH cooking appliance 300 recognizes that the proper magnetic material cooker 303 is not put on the top plate 301 by the proper pan detection function thereof, and thus the operation of the IH cooking appliance is stopped.

Next, an operation of the electric power supply apparatus 100 will now be explained with reference to FIGS. 5 and 6.

First, the electric power supply apparatus 100 is put on the top plate 301 of the IH cooking appliance 300 (step S1). At this time, the power generation coil 10 and the load 200 are isolated from each other by the breaker section 40.

Then, the IH cooking appliance 300 is powered ON so as to be started (step S2).

At the start, the proper pan detection function of the IH cooking appliance 300 works. Thus, IH cooking appliance 300 emits intermittent magnetic force lines as a scan wave (step S3). Note, in this first embodiment, the emission of the magnetic force lines is carried out one time at the interval of 2 sec., and the emissions of the scan wave are continued over a time period of 3 min. until a proper magnetic material cooker 303 is detected. When the proper magnetic material cooker 303 is not detected during the timer period of 3 min., the IH cooking appliance 300 is automatically powered OFF.

The intermittent magnetic force lines cause an induction current in the power generation coil 10 so that a constant voltage is supplied to the control section 20 through the control power generation section 60. Note that the power generation coil 10 and the load 200 are isolated from each other by the breaker section 40 so that the induction current are not supplied to the load 200. Namely, at this point, the IH cooking appliance 300 recognizes that the proper magnetic material cooker 303 is not put on the top plate because no power is consumed by the load.

When the constant voltage is supplied to the control section 20, it starts (step S4), and the control section 20 gives a command for the detection section 50 to detect physical quantities created in the power generation coil 10, the breaker section 40 and/or the load 200.

The detection section 50 detects the physical quantities created in the power generation coil 10, the breaker section 40 and/or the load 200 (step S5), converts them into corresponding signals, and then inputs them to the control section 20.

The control section 20 compares the respective physical quantities, detected by the detection section 50, with reference values, and determines whether each of the detected physical quantities falls within a given range (step S6).

At step S6, when it is determined that each of the detected physical quantities does not fall within the given range, the breaker section 40 cannot be driven. Namely, after a given time (i.e., 3 min. during which the emissions of the scan wave are continued) has elapsed (step S7), the IH cooking appliance 300 is automatically powered OFF (step S8), so that the supply of the constant voltage to the control section is stopped, and thus the operation of the electric power supply apparatus 100 ends.

Also, at step S6, when it is determined that each of the detected physical quantities falls within the given range, the control section 20 drives the breaker section 40 so that an electrical connection is established between the power generation coil 10 and the load 200 (step S9).

Then, an induction current created in the power generation coil 10 by the intermittent magnetic force lines is supplied as a constant voltage to the load 200 through the rectifying/smoothing circuit section 30, so that a power is consumed by the load 200.

At this time, in the IH cooking appliance 300, it is determined whether an electric power consumed by an article to be heated falls within a given range (more than 300 W) by the proper pan detection function (step S10).

At step S10, when the IH cooking appliance 300 determines that the electric power consumed by the article to be heated does not fall within a given range (more than 300 W), it is determined whether the given time (i.e., 3 min. during which the emissions of the scan wave are continued) has elapsed (step S11).

At step S11, when the IH cooking appliance 300 determines that the given time (i.e., 3 min. during which the emissions of the scan wave are continued) has elapsed, the IH cooling appliance 300 is automatically powered Off, and thus the operation of the electric power supply apparatus 100 ends.

Also, at step S10, when the IH cooking appliance 300 determines that the electric power consumed by the article to be heated falls within a given range (more than 300 W), the IH cooking appliance 300 starts a normal operation (step S12) so as to emits continuous magnetic force lines.

Note, on the normal operation of the IH cooking appliance 300 (step S13), physical quantities created in the power generation coil 10, the breaker section 40 and/or the load 200 are periodically detected by the detection section 50 or this detection is carried out when each of the physical quantities varies (step S14), and the detection section 50 converts the detected physical quantities into corresponding signals, and then inputs them to the control section 20. Especially, when the electrified appliance forming the load 200 is intentionally powered OFF, a physical quantity created in the load 200 falls outside the given range because no power is consumed by the load 200.

The control section 20 compares the respective physical quantifies, detected by the detection section 50, with the reference values, and determines whether each of the detected physical quantifies falls within the given range (step S15).

At step S15, when it is determined that each of the detected physical quantifies falls within the given range, in the control section 20, the control returns to step S13 without driving the breaker section 40.

Also, at step S15, when it is determined that each of the detected physical quantifies does not fall within the given range, the control section 20 drives the breaker section 40 so that the power generation coil 10 and the load 200 are isolated from each other (step S16).

Thus, by the IH cooking appliance 300, it is determined that the electric power consumed by the article to be heated falls outside the given range (less than 300 W), and the normal mode, which is the normal operation to emit the continuous magnetic force lines, is changed into the scan mode in which the intermittent magnetic force lines are emitted to thereby execute the proper pan detection function. Then, after the given time (i.e., 3 min. during which the emissions of the scan wave are continued) has elapsed, the IH cooking appliance 300 is automatically powered OFF (step S8), so that the supply of the constant voltage to the control section is stopped, and thus the operation of the electric power supply apparatus 100 ends.

Note, in this first embodiment, although the control power generation section 60, which is composed of the transformer 61, the diode bridge 62 and the constant voltage circuit section 63, and which is supplied with the induction current from the power generation coil 10, is used as the constant voltage power source for the control section 20, as shown in FIGS. 7 and 8, a control power source section 70, which is independent from the power generation coil 10, may be used as the constant voltage power source for the control section 20.

In this control power source section 70, batteries may be used. Since operating voltages of PIC16F84 are includes in a range from 2 to 6V, at least one or at most four 1.2-1.5 V batteries, which are connected in series to each other, are sufficient for the control power source section. Also, when a 9 V battery 006P is substituted for the four 1.5 V batteries, 9 V may be converted to 5 V by a 3-terminal regulator 7805 to supply it to PIC.

Like this, when the batteries are used as a constant power source for the control section 20, since the power generation coil 10 and the control section 20 are completely isolated from each other, spark noise can be prevented from being penetrated into the control section 20. Nevertheless, it is preferable that the control power generation section 60 supplied with the induction current from the power generation coil 10 is used as the constant voltage source because of a troublesome change of batteries.

### Second Embodiment of Present Invention

FIG. 9 is a conceptual view for explaining an electric power supply apparatus in a second embodiment for embodying the present invention; FIG. 10 is a circuit diagram showing an example of a concrete circuit arrangement of the electric power supply apparatus of FIG. 9; FIG. 11(a) is graph showing a relationship between a consumption power in a load and a consumption power in a dummy power consumption section on the condition that a power consumed by the dummy power consumption section is constant; FIG. 11(b) is a graph showing a relationship between a consumption power in a load and a consumption power in a dummy power consumption section on the condition that a power consumed by the dummy power consumption section is variable; FIG. 12 is a flowchart for explaining an operation of the electric power supply apparatus of FIG. 9; FIG. 13 is a remaining part of the flowchart of FIG. 12; and FIG. 14 is the remaining part of the flowchart of FIG. 13. In FIGS. 9 to 14, the same references as in FIGS. 1 to 8 indicate the same or corresponding elements, and explanations of these elements are omitted.

This second embodiment is different from the first embodiment only in that the electric power supply apparatus 100 includes a dummy power consumption section 80 as a substitute for the breaker section 40, and has the similar functions and effects to those of the first embodiment except for below-mentioned functions and effects obtained from the dummy power consumption section 80.

As stated above, the IH cooking appliance 300 is equipped with a function which detects that the proper magnetic material cooker 303 is put on the top plate 301 when a consumption power of an article to be heated, which is put on the top plate 301, falls within a given range (for example, more than 300 W).

For this reason, when the consumption power in the load side including the load 200 connected to the electric power supply apparatus 100 falls outside the given range (less than 300 W), the operation of the IH cooking appliance is stopped due to the proper detection function, and thus a power source for the load 200 cannot be obtained.

Thus, as shown in FIGS. 9 and 10, the electric power supply apparatus 100 of the second embodiment is provided with the dummy power consumption section 80 in which a power is consumed in a quasi-manner to supplement a lack of the consumption power in the load 200 so that a resultant consumption power falls within the given range (more than 300 W).

The dummy power consumption section 80 is connected to the power generation coil 10 so that the circuits of the control section 20 connected to the power generation coil 10 through the control power generation section 60 are put therebetween, and forms a means for consuming the power in the quasi-manner. Also, in the dummy power consumption section 80, the consumption power to be consumed in the quasi-manner is controlled by the control section 20 based on signals output from the detection section 50.

Note, in this first embodiment, the dummy power consumption section 80 uses a resistor 83 which is connected to and disconnected from the power generation coil 10 by a relay 81, and contacts of a switch portion 81b are opened and closed by a relay coil 81a. Also, for the supply of current to the relay coil 81a to make it function as an electromagnet for attracting the switch portion 81b, an NPN bipolar transistor is used as a relay driver element 82. Also, a base of the NPN bipolar transistor forming the relay driver element 82 is connected to RA1 (Pin Number 8) of PIC forming the control section 20, which is I/O port A (bit 1) thereof; a collector of the NPN bipolar transistor is connected to an output side of the control power generation section 60; and an emitter of the NPN bipolar transistor is connected to the relay coil 81a. Also, the resistor 83 connected in series to the switch portion 81b is connected in parallel to the power generation coil 10 and the diode bridge 31.

As long as the resistor 83 forming the dummy power consumption section 80 consumes the power to supplement the lack of the consumption power in the load 200 so that the resultant consumption power falls within the given range, it is not subjected to any limitations. Nevertheless, as shown in FIG. 11(a), it is preferable to use the resistor 83 which consumes the power of at least 300 W, because a total consumption power in the load including the dummy power consumption section 80 becomes more than 300 W although the consumption power in the load 200 is close to 0 W.

Also, a power consumed by the dummy power consumption section 80 is a wasteful power consumed outside the load 200. It is also wasteful that a power is always consumed by the dummy power consumption section 80 during a supply of power to the load 300 from the electric power supply apparatus 100, and there may be a case where the resistor 83 is even heated.

Thus, the contacts of the switch portion 81b of the relay 81 may be opened and closed at intervals of time (for example, 0.5 sec.) at which the proper pan detection function of the IH cooking appliance 300 cannot work, it is possible to reduce a consumption power per unit time (substantially 150 W). In this case, an open/close of the contacts of the switch portion 81b is automatically regulated by a calculation in the control section 20 so that an electrical connection between the power generation coil 10 and the load 200 can be maintained.

Also, in FIG. 10, although the relay 81 is used as an electronic part by which the resistor 83 is connected to and disconnected from the power generation coil 10, a TRIAC may be substituted therefor. Like this, by using the TRIAC, it is possible to variably regulate a power to be consumed by the resistor 83, and thus, as shown in FIG. 11(b), the total consumption power in the load including the dummy power consumption section 80 can be regulated so as to become the lowest limit (300 W) of the given range. Accordingly, it is possible to minimally suppress the wasteful consumption power (i.e., the consumption power in the dummy power consumption section 80) consumed outside the load 200.

Next, an operation of the electric power supply apparatus 100 will now be explained with reference to FIGS. 12 to 14.

First, the electric power supply apparatus 100 is put on the top plate 301 of the IH cooking appliance 300 (step S101). At this time, the power generation coil 10 and the resistor 83 are isolated from each other by the relay 81.

Then, the IH cooking appliance 300 is powered ON so as to be started (step S102).

At the start, the proper pan detection function of the IH cooking appliance 300 works. Thus, IH cooking appliance 300 emits intermittent magnetic force lines as a scan wave (step S103). Note, in this second embodiment, the emission of the magnetic force lines is carried out one time at the interval of 2 sec., and the emissions of the scan wave are continued over a time period of 3 min. until a proper magnetic material cooker 303 is detected. When the proper magnetic material cooker 303 is not detected during the timer period of 3 min., the IH cooking appliance 300 is automatically powered OFF.

The intermittent magnetic force lines cause an induction current in the power generation coil 10 so that a constant voltage is supplied to the control section 20 through the control power generation section 60. Also, the induction current is supplied to the load 200. When a consumption power in the load 200 falls within the given range (more than 300 W), the IH cooking appliance 300 determines that a consumption power of an article to be heated falls within a given range (more than 300 W), starts a normal operation, and thus emits continuous magnetic force lines. On the other hand, when the consumption power in the load 200 falls outside the given range (less than 300 W), the IH cooking appliance 300 determines that the consumption power of the article to be heated falls outside a given range (less than 300 W), does not start the normal operation, and thus still emits a scan wave. Note, in this second embodiment, since it is assumed that the consumption power in the load 200 falls outside the given range (less than 300 W) except for the consumption power in the dummy power consumption section 80, at this time, the IH cooking appliance 100 does not starts the normal operation.

When the constant voltage is supplied to the control section 20, it starts (step S104), and the control section 20 gives a command for the detection section 50 to detect physical quantities created in the power generation coil 10, the dummy power consumption section 80 and/or the load 200.

The detection section 50 detects the physical quantities created in the power generation coil 10, the dummy power consumption section 80 and/or the load 200 (step S105), converts them into corresponding signals, and then inputs them to the control section 20.

The control section 20 compares the respective physical quantities, detected by the detection section 50, with reference values, and determines whether each of the detected physical quantities falls within a given range (step S106).

At step S106, when it is determined that each of the detected physical quantities does not fall within the given range, the consumption power in the dummy power consumption power 80 is controlled by the control section 20, so that a total consumption power in the load 200 including the dummy power consumption section 80 falls outside a set range (less than 300 W: preferably, the consumption power is made to be sufficiently small so that it is not mistaken by the IH cooking appliance 300 that the proper magnetic material cooker 303 is put on the top plate). Note, in this second embodiment, since it is assumed that the consumption power in the load 200 falls outside the given range (less than 300 W) except for the consumption power in the dummy power consumption section 80, at this time when the power generation coil 10 and the resistor 83 are isolated from each other by the relay 81, the IH cooking appliance 100 does not starts the normal operation.

Then, after a given time (i.e., 3 min. during which the emissions of the scan wave are continued) has elapsed, the IH cooking appliance 300 is automatically powered OFF (step S108), so that the supply of the constant voltage to the control section is stopped, and thus the operation of the electric power supply apparatus 100 ends.

Also, at step S106, when it is determined that each of the detected physical quantities falls within the given range, a current value and a voltage value in the load 200 are detected by the detection section 50, and then a consumption power in the load 200 is calculated by the control section 20 (step S109).

Then, the control section 20 determines whether the consumption power in the load 200 falls within the set range (more than 300 W) (step S110).

At step S110, when the control section 20 determines that the consumption power does not fall within the set range (more than 300 W), the consumption power in the dummy power consumption section 80 is controlled by the control section 20 so that the total consumption power in the load 200 including the dummy power consumption section 80 falls within the set range (step S111).

Note, in the dummy power consumption section 80 in which the resistor 83 is connected to and disconnected from the power generation coil 10 by the relay 81, as shown in FIG. 10, when the contacts of the switch portion 81b of the relay 81by is closed, the constant power (300 W) is consumed by the resistor 83, as shown in FIG. 11(a). Also, in the dummy power consumption section 80 in which the consumption power in the resistor 83 is variably controlled by a not shown TRIAC, the consumption power in the resistor 83 is regulated by the TRIAC so that the total consumption power in the load 200 including the dummy power consumption section 80 becomes the lowest limit (300 W) of the set range, as shown in FIG. 11(b).

Then, an induction current created in the power generation coil 10 by the intermittent magnetic force lines is supplied as a constant voltage to the load 200 through the rectifying/smoothing circuit section 30, so that a power is consumed by the load 200. Also, a power is consumed by the dummy power consumption section 80.

At this time, in the IH cooking appliance 300, it is determined that an electric power consumed by an article to be heated falls within a given range (more than 300 W) by the proper pan detection function (step S112), and the IH cooking appliance 300 starts a normal operation (step S113) so that so as to emits continuous magnetic force lines.

Note, on the normal operation of the IH cooking appliance 300 (step S114), physical quantities created in the power generation coil 10, the dummy power consumption section 80 and/or the load 200 are periodically detected by the detection section 50 or this detection is carried out when each of the physical quantities varies (step S115), and the detection section 50 converts the detected physical quantities into corresponding signals, and then inputs them to the control section 20. Especially, when the electrified appliance forming the load 200 is intentionally powered OFF, a physical quantity created in the load 200 falls outside the given range because no power is consumed by the load 200.

The control section 20 compares the respective physical quantities, detected by the detection section 50, with the reference values, and determines whether each of the detected physical quantities falls within the given range (step S116).

At step S116, when it is determined that each of the detected physical quantities falls within the given range, in the control section 20, the control returns to step S114, with the contacts of the switch portion 81b being closed. Note, if the TRIAC is substituted for the relay 81, the control returns to step S114 without varying the consumption power in the resistor 83.

Also, at step S116, when it is determined that each of the detected physical quantities does not fall within the given range, the consumption power in the dummy power consumption power 80 is controlled by the control section 20, so that the total consumption power in the load 200 including the dummy power consumption section 80 falls outside the set range (less than 300 W: preferably, the consumption power is made to be sufficiently small so that it is not mistaken by the IH cooking appliance 300 that the proper magnetic material cooker 303 is put on the top plate) (step 117). Namely, the control section 20 drives the relay 81 so that the power generation coil 10 and the resistor 83 are isolated from each other. Note, if the TRIAC is substituted for the relay 81, the consumption power in the resistor 83 is reduced, the regulation is carried out so that the total consumption power in the load 200 including the dummy power consumption section 80 falls outside the set range.

Thus, by the IH cooking appliance 300, it is determined that the electric power consumed by the article to be heated falls outside the given range (less than 300 W), and the normal mode, which is the normal operation to emit the continuous magnetic force lines, is changed into the scan mode in which the intermittent magnetic force lines are emitted to thereby execute the proper pan detection function. Then, after the given time (i.e., 3 min. during which the emissions of the scan wave are continued) has elapsed, the IH cooking appliance 300 is automatically powered OFF (step S108), so that the supply of the constant voltage to the control section is stopped, and thus the operation of the electric power supply apparatus 100 ends.

Note, in this first embodiment, although the control power generation section 60, which is composed of the transformer 61, the diode bridge 62 and the constant voltage circuit section 63, and which is supplied with the induction current from the power generation coil 10, is used as the constant voltage power source for the control section 20, similar to the first embodiment, the control power source section 70, which is independent from the power generation coil 10, may be used as the constant voltage power source for the control section 20.

### Third Embodiment of Present Invention

FIG. 15 is a conceptual view for explaining an electric power supply apparatus in a third embodiment for embodying the present invention; FIG. 16 is a circuit diagram showing an example of a concrete circuit arrangement of the electric power supply apparatus of FIG. 15; FIG. 17 is a flowchart for explaining an operation of the electric power supply apparatus of FIG. 15; FIG. 18 is a remaining part of the flowchart of FIG. 17; and FIG. 19 is the remaining part of the flowchart of FIG. 18. In FIGS. 15 to 19, the same references as in FIGS. 1 to 4 indicate the same or corresponding elements, and explanations of these elements are omitted.

This third embodiment is different from the first and second embodiments only in that the electric power supply apparatus 100 includes a breaker section 40 and a dummy power consumption section 80, and has the similar functions and effects to those of the first and second embodiments except for below-mentioned functions and effects obtained from the breaker section 40 and the dummy power consumption section 80.

In the electric power supply apparatus 100 of the above-mentioned first embodiment, when the consumption power in the load side including the load 200 connected to the electric power supply apparatus 100 falls outside the given range (less than 300 W), the operation of the IH cooking appliance is stopped due to the proper detection function, and thus a power source for the load 200 cannot be obtained.

Also, in the electric power supply apparatus 100 of the above-mentioned second embodiment, when the total consumption power in the load side including the load 200 connected to the electric power supply apparatus 100 falls within the given range (more than 300 W), it is impossible to stop the supply of the power to the load 200 except for a case where either an electrified appliance forming the load 200 or the IH cooking appliance 300 is intentionally turned OFF.

In particular, in a case where a fault occurs in circuit elements, of which either the electrified appliance forming the load 200 or the electric power supply apparatus 100 is composed, although the fault is detected by the detection section 50 to thereby regulate the dummy power consumption section 80 (null consumption power), it is impossible to stop the supply of the power to the load 200 because the consumption power in the load side except for the dummy power consumption section 80 falls the given range (more than 300 W). As a result, an excess current flows through the circuit elements, of which either the load 200 or the electric power supply apparatus 100 is composed, so that the circuit elements may be subjected damage.

Thus, as shown in FIGS. 15 and 16, the electric power supply apparatus 100 of this third embodiment is provided with a combination of the breaker section 40 and the dummy power consumption section 80.

Next, an operation of the electric power supply apparatus 100 will now be explained with reference to FIGS. 17 to 19.

First, the electric power supply apparatus 100 is put on the top plate 301 of the IH cooking appliance 300 (step S201). At this time, the power generation coil 10 and the load 200 are isolated from each other by the breaker section 40, and the power generation coil 10 and the resistor 83 are isolated from each other by the relay 81.

Then, the IH cooking appliance 300 is powered ON so as to be started (step S202).

At the start, the proper pan detection function of the IH cooking appliance 300 works. Thus, IH cooking appliance 300 emits intermittent magnetic force lines as a scan wave (step S203). Note, in this second embodiment, the emission of the magnetic force lines is carried out one time at the interval of 2 sec., and the emissions of the scan wave are continued over a time period of 3 min. until a proper magnetic material cooker 303 is detected. When the proper magnetic material cooker 303 is not detected during the timer period of 3 min., the IH cooking appliance 300 is automatically powered OFF.

The intermittent magnetic force lines cause an induction current in the power generation coil 10 so that a constant voltage is supplied to the control section 20 through the control power generation section 60. Note that the power generation coil 10 and the load 200 are isolated from each other by the breaker section 40 so that the induction current are not supplied to the load 200 including the dummy power consumption section 80. Namely, at this point, the IH cooking appliance 300 recognizes that the proper magnetic material cooker 303 is not put on the top plate because no power is consumed by the load.

When the constant voltage is supplied to the control section 20, it starts (step S204), and the control section 20 gives a command for the detection section 50 to detect physical quantities created in the power generation coil 10, the breaker section 40, the dummy power consumption section 80 and/or the load 200.

The detection section 50 detects the physical quantities created in the power generation coil 10, the breaker section 40, the dummy power consumption 80 and/or the load 200 (step S205), converts them into corresponding signals, and then inputs them to the control section 20.

The control section 20 compares the respective physical quantities, detected by the detection section 50, with reference values, and determines whether each of the detected physical quantities falls within a given range (step S206).

At step S206, when it is determined that each of the detected physical quantities does not fall within the given range, the breaker section 40 cannot be driven. Namely, after a given time (i.e., 3 min. during which the emissions of the scan wave are continued) has elapsed (step S207), the IH cooking appliance 300 is automatically powered OFF (step S208), so that the supply of the constant voltage to the control section is stopped, and thus the operation of the electric power supply apparatus 100 ends.

Also, at step S206, when it is determined that each of the detected physical quantities falls within the given range, the control section 20 drives the breaker section 40 so that an electrical connection is established between the power generation coil 10 and the load 200 (step S209).

Then, an induction current created in the power generation coil 10 by the intermittent magnetic force lines is supplied as a constant voltage to the load 200 through the rectifying/smoothing circuit section 30, so that a power is consumed by the load 200.

Then, a current value and a voltage value in the load 200 are detected by the detection section 50, and then a consumption power in the load 200 is calculated by the control section 20 (step S210).

Then, the control section 20 determines whether the consumption power in the load 200 falls within a set range (more than 300 W) (step S211).

At step S211, when the control section 20 determines that the consumption power does not fall within the set range (more than 300 W), the consumption power in the dummy power consumption section 80 is controlled by the control section 20 so that the total consumption power in the load 200 including the dummy power consumption section 80 falls within the set range (step S211).

Note, in the dummy power consumption section 80 in which the resistor 83 is connected to and disconnected from the power generation coil 10 by the relay 81, as shown in FIG. 16, when the contacts of the switch portion 81b of the relay 81by is closed, the constant power (300 W) is consumed by the resistor 83, as shown in FIG. 11(a). Also, in the dummy power consumption section 80 in which the consumption power in the resistor 83 is variably controlled by a not shown TRIAC, the consumption power in the resistor 83 is regulated by the TRIAC so that the total consumption power in the load 200 including the dummy power consumption section 80 becomes the lowest limit (300 W) of the set range, as shown in FIG. 11(b).

Then, an induction current created in the power generation coil 10 by the intermittent magnetic force lines, a power is consumed by the dummy power consumption section 80.

At this time, in the IH cooking appliance 300, it is determined that an electric power consumed by an article to be heated falls within a given range (more than 300 W) by the proper pan detection function (step S212), and the IH cooking appliance 300 starts a normal operation (step S213) so that so as to emits continuous magnetic force lines.

Note, on the normal operation of the IH cooking appliance 300 (step S214), physical quantities created in the power generation coil 10, the breaker section 40, the dummy power consumption section 80 and/or the load 200 are periodically detected by the detection section 50 or this detection is carried out when each of the physical quantities varies (step S215), and the detection section 50 converts the detected physical quantities into corresponding signals, and then inputs them to the control section 20. Especially, when the electrified appliance forming the load 200 is intentionally powered OFF, a physical quantity created in the load 200 falls outside the given range because no power is consumed by the load 200.

The control section 20 compares the respective physical quantities, detected by the detection section 50, with the reference values, and determines whether each of the detected physical quantities falls within the given range (step S216).

At step S216, when it is determined that each of the detected physical quantities falls within the given range, in the control section 20, the control returns to step S214 without driving the breaker section 40, with the contacts of the switch portion 81b being closed. Note, if the TRIAC is substituted for the relay 81, the control returns to step S214 without varying the consumption power in the resistor 83.

Also, at step S216, when it is determined that each of the detected physical quantities does not fall within the given range, the control section 20 drives the breaker section 40 so that the power generation coil 10 and the load 200 are isolated from each other (step S217). Note, in addition to the drive of the breaker section 40, for next use of the electric power supply apparatus 100, it is preferable to isolate the power generation coil 10 and the resistor 63 from each other by the relay 81.

Thus, by the IH cooking appliance 300, it is determined that the electric power consumed by the article to be heated falls outside the given range (less than 300 W), and the normal mode, which is the normal operation to emit the continuous magnetic force lines, is changed into the scan mode in which the intermittent magnetic force lines are emitted to thereby execute the proper pan detection function. Then, after the given time (i.e., 3 min. during which the emissions of the scan wave are continued) has elapsed, the IH cooking appliance 300 is automatically powered OFF (step S208), so that the supply of the constant voltage to the control section is stopped, and thus the operation of the electric power supply apparatus 100 ends.

Note, in this third embodiment, although the control power generation section 60, which is composed of the transformer 61, the diode bridge 62 and the constant voltage circuit section 63, and which is supplied with the induction current from the power generation coil 10, is used as the constant voltage power source for the control section 20, similar to the first embodiment, the control power source section 70, which is independent from the power generation coil 10, may be used as the constant voltage power source for the control section 20.

### Fourth Embodiment of Present Invention

FIG. 20 is an explanatory view for explaining a principle of a Peltier module utilizing the Peltier effect; FIG. 21(a) is a cross-sectional view showing a structure of the Peltier module; FIG. 21(b) is a plan view showing a structure of the Peltier module; FIG. 22 is an explanatory view showing an operation principle of the Peltier module; FIG. 23(a) is a circuit diagram showing an example for supplying the Peltier module with an electric power; FIG. 23(b) is a circuit diagram showing another example for supplying the Peltier module with an electric power; FIG. 24 is a cross-sectional view showing a structure of a radiator for cooling a heat dispersion side of the Peltier module; FIG. 25(a) is a plan view showing a schematic structure of an electric power supply apparatus which can be used as both a cooling apparatus and a heating apparatus by front and rear faces of the Peltier module; FIG. 25(b) is a cross-sectional view of the electric power supply apparatus taken along the A-A line of FIG. 25(a); FIG. 26(a) is a plan view showing a schematic structure of another electric power supply apparatus which can be used as both a cooling apparatus and a heating apparatus by front and rear faces of the Peltier module; and FIG. 26(b) is a cross-sectional view of the other electric power supply apparatus taken along the B-B line of FIG. 26(a). In FIGS. 20 to 26, the same references as in FIGS. 1 to 19 indicate the same or corresponding elements, and explanations of these elements are omitted.

This fourth embodiment is different from the first, second and third embodiments only in that a Peltier module 210 is used in the load 200, and has the similar functions and effects to those of the first, second and third embodiments except for below-mentioned functions and effects obtained from the Peltier module 210. Here, the Peltier effect is explained with reference to FIG. 20.

The Peltier effect is the fact that, when a current flows into a junction between two kinds of metals or semiconductor, heat is transferred from one kind metal or semiconductor to the other kind of metal or semiconductor. In order to use this effect, as shown in FIG. 20, a Peltier module is constructed by alternately disposing p-type semiconductors 211 and n-type semiconductors 212 on a plane, and by connecting them in series to each other with metal electrode plates 213 and 214. When a direct current flows into the Peltier module, one metal electrode plate 214 is defined as a heat absorption side so that it is cooled, and the other metal electrode plate 213 is defined as a heat dispersion side so that its temperature is elevated.

In particular, in the Peltier module 200 forming the load 200, as shown in FIG. 21, the p-type semiconductors 211 and the n-type semiconductors 212 are alternately disposed on the plane, and are connected in series to each other by the metal electrode plates 213 and 214, with these elements as a whole being arranged as if drawn with a single stroke. The elements may be also arranged in a spiral manner. Ceramic plates 215 and 216 are adhered to the respective metal electrode plates 213 and 214, resulting in production of the Peltier module 210. Terminal ends of the metal electrode 213 are connected to each other by a conductor 2, in which a diode 3 is intervened therein, to thereby form a closed loop circuit.

With this arrangement, the alternating magnetic field created in the magnetism creating coil 302 of the IH cooking appliance is induced in the closed loop circuit formed by the Peltier module 210 and the conductor 2, and the rectification is carried out by the diode 3, so that a one-directional current or direct current flows into the Peltier module 210, and thus a heat absorption is caused in the side of the ceramic plate 216. Accordingly, when a pan (preferably made of insulative material such as glass) is put on the ceramic plate 216, a cooked foodstuff in the pan is cooled. Note, since the underneath ceramic plate 215 is defined as the heat dispersion side, the cooling effect can be facilitated by cooling it with the fan 220. Also, it is possible to facilitate the cooling effect by contacting the side of the ceramic plate with a cooling medium which is circulated by a below-mentioned radiator 250

Next, an operation principle of the Peltier module 210 is explained with reference to FIG. 22. The Peltier module 210 is provided with a coil 1 arranged therebeneath, and the coil 1 and the Peltier module 210 are connected to each other through the intermediary of the conductor 2 and the diode 3. When the Peltier module 210 is put on the top plate 301 of the IH cooking appliance 300, a vertical alternating magnetic field is generated in the magnetism generation coil 302 by a high frequency current flowing into the magnetism generation coil 302 arranged beneath the top plate 301. Due to the alternating magnetic field, a current is induced in the coil 1, and is rectified by the diode 3, so that a one-directional current flows into the p-type semiconductors 211 and the n-type semiconductors 212, which are the Peltier elements, to thereby cool the face side of the Peltier module. When a pan or a container is put on the Peltier module 210, a cooked foodstuff in the pan or the container is rapidly cooled.

When the only single rectification diode 3 is intervened between the coil 1 and both the Peltier module 210 and the conductor 2, as shown in FIG. 23(a), a current flowing into the Peltier module 210 features a half-wave rectification wave shape, so that an average current is a half of that based on a full-wave rectification, resulting in decline of efficiency. Thus, when a diode bridge 31 is substituted for the single diode 3, a direct current featured by the full-wave rectification flows into the Peltier module 210, so that the double current can flow into the Peltier module in comparison with the case using the single diode. Thus, it is possible to further facilitate the cooling efficiency.

As stated above, although the explanation is directed to the fact that the side of the electrode plate 214 of the Peltier module 210 is cooled, the Peltier module 210 has the cooled side and the heated side due to the transfer of heat. For this reason, the electrode plate 213 opposed to the cooling side is heated, and the heat in the side of the electrode plate 213 is conducted into the electrode plate 214 in the cooling side, to thereby cause a phenomenon in which the cooling side cannot be cooled less than a certain temperature. Thus, as shown in FIG. 24, the Peltier module may be equipped with a radiator 250.

In FIG. 24, a heat radiation plate 251 formed of a non-ferromagnetic material such as aluminum and so forth is adhered to the bottom face of the Peltier module 210, and the Peltier module is fixed on a top surface of a casing 252 for a nonmetal material such as a plastic material and so forth. The coil 1 having several turns is disposed on the inner bottom of the casing 252 so as to be able to close to the top plate 301 of the IH cooking appliance 300, and the container 254 having a water or another cooling medium is received in the casing. The radiator 250 is displaced outside the casing 252, and radiates heat from the cooling medium through circulation pipes 255. Note that an electric source for a not shown fan of the radiator 250 can be obtained by conducting a high frequency current induced in the coil 1 to the radiator through electric wires 256, and by rectifying it therein.

Note that a placing area of the Peltier module can be made small by receiving the radiator 250 and the circulation pipes 255 in the casing 252. With this arrangement, a user can be released from a troublesome work that the radiator 250 and the circulation pipes 255 must be disposed beside the casing 252 whenever the Peltier module is used.

The Peltier module 210 may comprise at least one Peltier module available from the market. For example, when twenty modules of 12 V, 6 Aₘₐₓ and the maximum heart absorption 57 W are used, the total consumption power is 864 W, which can be covered with a high frequency magnetic field generated by a 600-800 W IH cooking appliance 300 (an ordinary IH cooking appliance has an output of more than 1000 W).

Since the Peltier Module 210 features the usable maximum temperature of 150° C. which is less than a solder melting temperature, when a water-cooled method is used, the temperature of the Peltier module cannot exceed 100° C. to thereby insure safety. When a temperature of the heating side of the Peltier module is 50° C., a temperature of the cooling side thereof is −22° C. in calculation, and thus a sufficient cooling effect can be obtained.

Thus, by cooling the heating side of the Peltier elements, it is possible to lower the temperature of the cooling side thereof.

As stated above, in a case where the electric power supply apparatus 100 is used as a cooling apparatus, although the explanation is directed to the example in which, by putting the Peltier module 210 on the top plate 301 of the IH cooking appliance 300, and by putting a cooking container such as a pan on the Peltier module 210, a cooked foodstuffs in the cooking container are cooled, a variety of applications is considered as stated below.

First of all, by changing a polarity of the diode 3, the top portion of the Peltier module 210 can be used as a heat dispersion face. In the IH cooking appliance 300, an article to be put thereon is made of a metal material such as steel having a suitable electrical resistance, and is heated based of the generation of the Joule heat resulted from the eddy currents. This means that a cooking container made of insulative material such as glass cannot be heated by the IH cooking appliance 300. By utilizing the top face of the Peltier module 210 according to the present invention as the heat dispersion face, it is possible to heat a glass pan put thereon, i.e., the glass pan, which could not be heated by the IH cooking appliance 300 until now, can be used therein. Also, the induction heating method is directed to the application of heat at a high temperature, and is unsuitable to keep a cooked foodstuff warm. For this reason, although a heating temperature is set to be low, a “slow fire” temperature can be merely obtained, and thus a cooked foodstuff in the pan may be burned when the pan is put on the IH cooking appliance over a long time. In contrast, by utilizing the top face of the Peltier module 210 according to the present invention as the heat dispersion face, it is possible to keep a cooked foodstuff worm at a low temperature, and thus the cooked foodstuff can be heated over a long time at a degree of temperature at which the cooked foodstuff cannot be cooled.

Note, as show in FIG. 25, the Peltier module 210 may be disposed at a coil-less central portion of the power generation coil 10, which is a central area of the power generation coil 10 turned in a spiral manner on the same plane, and fans 220 for cooling the heat dispersion face of the Peltier module 210 may be disposed at a coil-less peripheral portion of the Peltier module 210, which is an outside area of the power generation coil 10 turned in the spiral manner on the same plane.

With this arrangement, when a heat absorption face 210a of the Peltier module 210 is defined as the top face with respect to the top plate 301 of the IH cooking appliance 300, the electric power supply apparatus 100 serves as a cooling apparatus, and it serves as a heating apparatus when a heat dispersion face 210b of the Peltier module 210 is defined as the top face.

Note, in order to improve a cooling efficiency of the heat dispersion face 210b based on the fans 220, it is preferable to define an optimum air-flow path in the interior of the electric power supply apparatus 100 so that an air introduced from the outside of the electric power supply apparatus 100 passes therethrough so as to be efficiently directed to the heat dispersion face 210b, and also it is preferable to form a space between the heat dispersion face 210b and an inner surface of a housing 110 of the electric power supply apparatus 100, to thereby increase an surface area of the heat dispersion face, with which an air is contacted.

For example, as shown in FIG. 26, it is considered that partition members 110c are arranged to define an air-flow path, so that an air, which is the outside of the housing 110 of the electric power supply apparatus 100, is aspirated by the fans 220, and so that an air, which is introduced from inlet ports 110a, provided in the housing 110, into the interior of the housing 110, flows in one side face of the Peltier module 210, then flows out of the other side face opposed to the one side face, and then is discharged from an outlet port 110b, provided in the housing 110, outside the housing 110. Especially, by disposing the fans 220 at two of the four corners of the interior of the housing 110 so that the airs flow in the two respective side faces of the Peltier modules 210, and flow out of the remaining two respective side faces of the Peltier modules 210, a synergy effect can be expected due to the two directional air-flows. Also, it is considered that not shown protrusions are disposed on either the inner face of the housing 110 opposed to the heat dispersion face 210a or the Peltier module 210 in order to ensure the formation of the space between the heat dispersion face 210b and the inner surface of a housing 110 of the electric power supply apparatus 100.

Note, although the fans 220 are driven when the electric power supply apparatus 100 is used as the cooling apparatus, the fans 220 may be stopped when the electric power supply apparatus 100 is used as the heating apparatus. In this case, it is considered that the drive and stop of the fans 220 is controlled by the control section 20, using either the photo-sensor or the inclination sensor provided in the detection section 50, by which a putting state of the electric power supply apparatus 100 put on the top plate 301 of the IH cooking appliance 300 is detected.

Also, an outer portion of each partition member 110c extended out of the power generation coil 10 may be shaped so that a space between the heat absorption face 210a and the heat dispersion face 210b is parted in two, and may be formed as a rotatable portion. In this case, when the electric power supply apparatus 100 is used as the cooling apparatus, the outer portion of the partition member 110c is abutted against the inner surface of the housing 110 on the side of the heat dispersion face 210b, and the fans 220 are used. When the electric power supply apparatus 100 is used as the heating apparatus, the outer portion of the partition member 110c is abutted against the inner surface of the housing 110 on the side of the heat absorption face 210a, and the fans 220 are used. Especially, in a case where not shown fins are provided on the heat absorption face 210a, when the electric power supply apparatus 100 is used as the heating apparatus, an air, which is introduced from the outside of the electric power supply apparatus 100, is directed to the fins so that the chilled air can be further diffused. Namely, heat beside the heat absorption face 210a are transferred to the low temperature side of the Peltier elements, so that it is possible to facilitate a heat dispersion in the heat dispersion face 210b.

Also, in each of the electric power supply apparatuses shown in FIG. 25(b) and FIG. 26(b), although the power generation coil 10 is illustrated as a single-turned layer at substantially the center in a direction in which a thickness of the electric power supply apparatus is measured, it may be formed as a plurality of multi-turned layers closed to the top and bottom inner surfaces of the housing 110 in that direction. Thus, in a case where the electric power supply apparatus 100 is put on the IH cooking appliance 300 so that either the top surface or the bottom surface of the housing 110 is contacted with the top plate 301, although the electric power supply apparatus 100 is used as either the cooling apparatus or the heating apparatus, a distance between the power generation coil 10 of the electric power supply apparatus 100 and the magnetism generation coil 302 of the IH cooking appliance 300 is not too large.

Secondly, the Peltier module 210 may be integrally built in a bottom of a pan. Thus, it is possible to provide a cooling pan which is used only for the IH cooking

Thirdly, in a cookhouse (for example, a Japanese-style pizza house, an inn, a restaurant and so forth), it is possible to use the electric power supply apparatus as a cooling apparatus at a place where IH cooking appliances 300 are provided on customer's tables as heating sources for cooking and heating.

For example, when a chilled cake such as an ice cream, a sherbet, a custard pudding and so forth is provided for dessert, it is possible to cool the chilled cake to thereby prevent it from melting or heating.

Also, when an assorted sashimi boat is provided first at a restaurant or a banqueting hall, it is possible to maintain freshness of the sashimi, using the electric power supply apparatus as the cooling apparatus, and it is possible to carry out a hot pot cooking or a grill cooking, using the heating function of the electric power supply apparatus 100 after the sashimi is ate.

Also, in a rotary sushi shop, by disposing magnetism generation coils 302 beneath a rotary conveyer belt, and by putting plates or trays, in which Peltier modules 210 are built in the bottoms thereof, on the rotary conveyer belt, it is possible to cool sushi and foodstuff to thereby maintain freshness of the sushi and foodstuff while they are even moved. It is possible to deal with a foodstuff, which is not desired to be cooled, by using an ordinary plate.

1. An electric power supply apparatus for supplying an electric power to a load based on an alternating magnetic field created by an induction heating cooking appliance which is equipped with a proper pan detection function to detect that an article to be heated is put on the induction heating cooking appliance as a proper magnetic material cooker when an electric power consumed by the article put on the induction heating cooking appliance, upon being irradiated with intermittent magnetic force lines, falls within a given range, which apparatus comprises:
a power generation coil that generates an induction current by crossing the power generation coil and an alternating magnetic field created by said induction heating cooking appliance, and that supplies it to said load;
a breaker section connected between said power generation coil and said load;
a detection section that detects physical quantities created in said power generation coil, said breaker section and/or said load; and
a control section that controls an electrical disconnection between said power generation coil and said load based on signals output from said,detection section,
characterized by the fact that, when a consumption power, which is consumed by said load when the electrical disconnection is established between said power generation coil and said load by said breaker section, falls outside a set range which is set by using as a standard a consumption power consumed by a magnetic material cooker put on said induction heating cooking appliance, said induction heating cooking appliance recognizes that the magnetic material cooker is not put thereon, to thereby stop the generation of the alternating magnetic field.

2. An electric power supply apparatus for supplying an electric power to a load based on an alternating magnetic field created by an induction heating cooking appliance which is equipped with a proper pan detection function to detect that an article to be heated is put on the induction heating cooking appliance as a proper magnetic material cooker when an electric power consumed by the article put on the induction heating cooking appliance, upon being irradiated with intermittent magnetic force lines, falls within a given range, which apparatus comprises:
a power generation coil that generates an induction current by crossing the power generation coil and an alternating magnetic field created by said induction heating cooking appliance, and that supplies it to said load;
a dummy power consumption section that consumes said induction current in a quasi-manner; and
a control section that controls a consumption power in said dummy power consumption section based on said induction current with respect to a set range which is set by using as a standard a consumption power consumed by a magnetic material cooker put on said induction heating cooking appliance,
characterized by the fact that, when a total consumption power, which is consumed by said load including said dummy power consumption section, falls outside said set range, said induction heating cooking appliance recognizes that the magnetic material cooker is not put thereon, to thereby stop the generation of the alternating magnetic field.

3. The electric power supply apparatus as set forth in claim 2, further comprising:
a breaker section connected between said power generation coil and said load; and
a detection section that detects physical quantities created in said power generation coil, said breaker section, said dummy power consumption section and/or said load,
characterized by the fact that said control section controls an electrical disconnection between said power generation coil and said load based on signals output from said detection section.

4. The electric power supply apparatus as set forth in claim 1, further comprising:
a control power generation section that generates constant voltages for said control section,
characterized by the fact that said control power generation section including a transformer connected between said power generation coil and said control section and stepping down a secondary voltage of the transformer to a primary voltage thereof, a diode bridge connected between said transformer and said control section and rectifying the alternating current from said power generation coil into a direct current, and a constant voltage circuit section connected between said diode bridge and said control section and supplying a constant voltage to said control section.

5. The electric power supply apparatus as set forth in claim 2, further comprising:
a control power generation section that generates constant voltages for said control section, characterized by the fact that said control power generation section including a transformer connected between said power generation coil and said control section and stepping down a secondary voltage of the transformer to a primary voltage thereof, a diode bridge connected between said transformer and said control section and rectifying the alternating current from said power generation coil into a direct current, and a constant voltage circuit section connected between said diode bridge and said control section and supplying a constant voltage to said control section.

6. The electric power supply apparatus as set forth in claim 3, further comprising:
a control power generation section that generates constant voltages for said control section,
characterized by the fact that said control power generation section including a transformer connected between said power generation coil and said control section and stepping down a secondary voltage of the transformer to a primary voltage thereof, a diode bridge connected between said transformer and said control section and rectifying the alternating current from said power generation coil into a direct current, and a constant voltage circuit section connected between said diode bridge and said control section and supplying a constant voltage to said control section.

7. The electric power supply apparatus as set forth in claim 4, characterized by the fact that an induction current is generated in said power generation coil by intermittently emitting magnetic force lines from said induction heating cooking appliance during an initial operation of said induction heating cooking appliance, and that said control section is started with constant voltages which are generated by said control power generation section based on said induction current.

8. The electric power supply apparatus as set forth in claim 5, characterized by the fact that an induction current is generated in said power generation coil by intermittently emitting magnetic force lines from said induction heating cooking appliance during an initial operation of said induction heating cooking appliance, and that said control section is started with constant voltages which are generated by said control power generation section based on said induction current.

9. The electric power supply apparatus as set forth in claim 6, characterized by the fact that an induction current is generated in said power generation coil by intermittently emitting magnetic force lines from said induction heating cooking appliance during an initial operation of said induction heating cooking appliance, and that said control section is started with constant voltages which are generated by said control power generation section based on said induction current.
